(19) United States
(12) Patent Application Publication
(10) Pub. No.: US 2020/0266932 A1
(43) Pub. Date: Aug. 20, 2020

(54) ACKNOWLEDGMENT FEEDBACK TECHNIQUES IN WIRELESS COMMUNICATIONS

(71) Applicant: QUALCOMM Incorporated, San Diego, CA (US)

(72) Inventors: Wei Yang, San Diego, CA (US); Jing Jiang, San Diego, CA (US); Yeliz Tokgoz, San Diego, CA (US)

(21) Appl. No.: 16/780,616

(22) Filed: Feb. 3, 2020

Related U.S. Application Data
(60) Provisional application No. 62/805,924, filed on Feb. 14, 2019.

(51) Int. Cl. H04L 1/18; H04W 72/14; H04W 72/12; H04W 72/04; H04B 17/318

(52) U.S. Cl. CPC H04L 1/1812; H04W 72/14; H04B 17/318; H04W 72/042; H04W 72/1273

(57) ABSTRACT

Methods, systems, and devices for wireless communications are described that provide for acknowledging receipt of a transmission, or triggering a retransmission, based on an initial decoding or measurement of the transmission. A user equipment (UE) may receive a downlink transmission and perform initial decoding or a measurement on the downlink transmission to determine an initial feedback for the downlink transmission. The initial feedback may be provided to a base station in a first set of uplink resources configured for initial feedback transmissions. The base station may receive the initial feedback, and may initiate a retransmission of the downlink transmission before a final feedback determination is made at the UE. In cases where a UE transmits an uplink transmission, the base station may perform initial decoding and may allocate retransmission resources to the UE prior to completing a final decoding of the uplink transmission.

### CROSS REFERENCE

The present application for patent claims the benefit of U.S. Provisional Patent Application No. 62/805,924 by YANG et al., entitled “ACKNOWLEDGMENT FEEDBACK TECHNIQUES IN WIRELESS COMMUNICATIONS,” filed Feb. 14, 2019, assigned to the assignee hereof, and expressly incorporated herein.

### BACKGROUND

The following relates generally to wireless communications, and more specifically to acknowledgment feedback techniques in wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Wireless communications systems may implement control messages (e.g., physical downlink control channel (PDCCH) messages transmitted by a base station) to grant upcoming resources for data transmissions (e.g., where the data transmissions are sent over a physical downlink shared channel (PDSCH)). If a UE receives and successfully decodes a PDCCH message, the UE may then receive and decode a data transmission in the data resources indicated by the PDCCH message, and transmit acknowledgment feedback to the base station to indicate successful receipt of the data transmission or unsuccessful receipt of the data transmission that triggers a retransmission of the data. For uplink transmissions, a PDCCH message may grant resources for uplink data transmissions (e.g., data transmissions send over a physical uplink shared channel (PUSCH)). If a base station unsuccessfully receives the uplink data transmission, further uplink resources may be granted for a retransmission of the uplink data. In cases where retransmissions of a downlink transmission or an uplink transmission are triggered, such retransmissions may add latency to a transmission. In cases where low latency is important (e.g., ultra-reliable low latency communications (URLLC)), additional latency may result in communications that do not meet latency targets. Thus efficient techniques that reduce latency in wireless communications may be beneficial to increase efficiency of a wireless communications system and help to more reliably meet latency targets for certain types of communications.

### SUMMARY

The described techniques relate to improved methods, systems, devices, and apparatuses that support acknowledgment feedback techniques in wireless communications. Various aspects of the present disclosure provide for acknowledging receipt of a transmission based on an initial decoding or measurement of the transmission, which may trigger a relatively low latency retransmission. In some cases, a user equipment (UE) may receive a downlink grant from a base station and may monitor associated downlink resources for a downlink transmission. The UE may perform initial decoding or a measurement on the downlink transmission and determine an initial feedback for the downlink transmission (e.g., an acknowledgment (ACK) or negative acknowledgment (NACK) feedback). In some cases, the UE may determine that the initial feedback is a NACK, and may transmit the initial feedback to the base station in a first set of uplink resources configured for initial feedback transmissions. The base station may receive the initial feedback, and may initiate a retransmission of the downlink transmission before a final feedback determination is made at the UE. In some cases, a reduced initial feedback processing timeline may be configured for initial feedback that is shorter than a final or regular feedback processing timeline.

In some cases, the UE may receive an uplink grant from the base station and may transmit an uplink transmission using resources indicated in the uplink grant. The base station, in some cases, may perform initial decoding or a measurement on the uplink transmission and make an initial determination as to whether the uplink transmission is likely to be successfully received. In cases where the initial determination indicates an unsuccessful decoding of the uplink transmission is a likely outcome, the base station may transmit a second uplink grant for the UE to retransmit the uplink transmission. In some cases, the base station may complete one or more decoding iterations on the initial uplink transmission and determine that the transmission is successfully decoded, and the base station may transmit a cancellation indication to the UE to cancel the uplink retransmission.

A method of wireless communication at a UE is described. The method may include receiving, from a base station, a first downlink grant that identifies a first set of downlink resources for a downlink transmission to the UE, identifying, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempting to decode the downlink transmission from the base station in the first set of downlink resources, and transmitting one or more of the first feedback transmission or the second feedback transmission based on whether the downlink transmission is successfully decoded.

An apparatus for wireless communication at a UE is described. The apparatus may include a processor, memory in electronic communication with the processor, and instructions stored in the memory. The instructions may be executable by the processor to cause the apparatus to receive, from a base station, a first downlink grant that identifies a first set of downlink resources for a downlink transmission to the UE, identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempt to decode the downlink transmission from the base station in the first set of downlink resources, and transmit one or more of the first feedback transmission or the second feedback transmission based on whether the downlink transmission is successfully decoded.

Another apparatus for wireless communication at a UE is described. The apparatus may include means for receiving, from a base station, a first downlink grant that identifies a first set of downlink resources for a downlink transmission to the UE, identifying, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempting to decode the downlink transmission from the base station in the first set of downlink resources, and transmitting one or more of the first feedback transmission or the second feedback transmission based on whether the downlink transmission is successfully decoded.

A non-transitory computer-readable medium storing code for wireless communication at a UE is described. The code may include instructions executable by a processor to receive, from a base station, a first downlink grant that identifies a first set of downlink resources for a downlink transmission to the UE, identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempt to decode the downlink transmission from the base station in the first set of downlink resources, and transmit one or more of the first feedback transmission or the second feedback transmission based on whether the downlink transmission is successfully decoded.

In some examples of the method, apparatuses, and non-transitory computer-readable medium described herein, attempting to decode the downlink transmission may include operations, features, means, or instructions for performing an initial decoding of the downlink transmission, and where the first feedback transmission is based on the initial decoding of the downlink transmission. In some examples of the method, apparatuses, and non-transitory computer-readable medium described herein, attempting to decode the downlink transmission further may include operations, features, means, or instructions for determining, after the initial decoding, a final decoding result of the downlink transmission, and where the second feedback transmission is based on the final decoding result of the downlink transmission. In some examples of the method, apparatuses, and non-transitory computer-readable medium described herein, the initial decoding may have a first processing time that is shorter than a second processing time associated with the final decoding, and where the starting time of the first set of uplink resources is later than a reference time plus the first processing time. In some examples of the method, apparatuses, and non-transitory computer-readable medium described herein, the reference time corresponds to an end time of the downlink transmission or to an end time of a demodulation reference signal transmitted in the downlink transmission. In some examples of the method, apparatuses, and non-transitory computer-readable medium described herein, a gap in time between an end time of the downlink transmission and a starting time of the first set of uplink resources may be smaller than the second processing time for the UE to determine the final decoding result of the downlink transmission.

In some examples of the method, apparatuses, and non-transitory computer-readable medium described herein, performing the initial decoding may include operations, features, means, or instructions for determining that a received power of the downlink transmission exceeds a threshold value. In some examples of the method, apparatuses, and non-transitory computer-readable medium described herein, the received power may be measured based on either a reference signal transmitted with a downlink control channel or a reference signal transmitted with a downlink data channel.

In some examples of the method, apparatuses, and non-transitory computer-readable medium described herein, performing the initial decoding may include operations, features, means, or instructions for performing a first number of decoding iterations on the downlink transmission, where the first number of decoding iterations may be less than a second number of decoding iterations to determine a final decoding result of the downlink transmission. In some examples of the method, apparatuses, and non-transitory computer-readable medium described herein, the first set of uplink resources at least partially overlaps in time with the first set of downlink resources.

Some examples of the method, apparatuses, and non-transitory computer-readable medium described herein may further include operations, features, means, or instructions for receiving, responsive to a negative acknowledgment feedback via the first set of uplink resources, a second downlink grant that identifies a second set of downlink resources for a retransmission of the downlink transmission to the UE, where the second downlink grant may be received prior to a starting time of the second set of uplink resources. In some examples of the method, apparatuses, and non-transitory computer-readable medium described herein, the second downlink grant indicates a single set of uplink resources for acknowledgment of the retransmission of the downlink transmission, and the UE transmits a single feedback transmission to acknowledge receipt of the retransmission of the downlink transmission based on the single set of uplink resources.

In some examples of the method, apparatuses, and non-transitory computer-readable medium described herein, identifying the first set of uplink resources and the second set of uplink resources may include operations, features, means, or instructions for receiving a resource indicator with the first downlink grant, and determining the first set of uplink resources and the second set of uplink resources based on a mapping of uplink resource pairs to an index value of the resource indicator.

Some examples of the method, apparatuses, and non-transitory computer-readable medium described herein may further include operations, features, means, or instructions for receiving, via a radio resource control configuration or a downlink grant, an indication of a feedback mode of the UE, wherein transmitting one or more of the first feedback transmission or the second feedback transmission is further based at least in part on the feedback mode of the UE.

In some examples of the method, apparatuses, and non-transitory computer-readable medium described herein, identifying the first set of uplink resources and the second set of uplink resources may include operations, features, means, or instructions for receiving a first resource indicator with the first downlink grant that indicates the first set of uplink resources, and a second resource indicator with the first downlink grant that indicates the second set of uplink resources.

In some examples of the method, apparatuses, and non-transitory computer-readable medium described herein, identifying the first set of uplink resources and the second set of uplink resources may include operations, features, means, or instructions for receiving a resource indicator with the first downlink grant that indicates the first set of uplink resources, and determining the second set of uplink resources based on a mapping between the first set of uplink resources and the second set of uplink resources. In some examples of the method, apparatuses, and non-transitory computer-readable medium described herein, the mapping indicates a relative timing difference between a first starting time of the first set of uplink resources and a second starting time of the second set of uplink resources.

In some examples of the method, apparatuses, and non-transitory computer-readable medium described herein, transmitting one or more of the first feedback transmission or the second feedback transmission may include operations, features, means, or instructions for transmitting the first feedback transmission based on an initial decoding of the downlink transmission indicating that the downlink transmission is unsuccessfully received, and skipping the transmitting of the first feedback transmission based on the initial decoding of the downlink transmission indicating that the downlink transmission is successfully received. In some examples of the method, apparatuses, and non-transitory computer-readable medium described herein, transmitting one or more of the first feedback transmission or the second feedback transmission further may include operations, features, means, or instructions for transmitting the second feedback transmission based on a final decoding result of the downlink transmission.

In some examples of the method, apparatuses, and non-transitory computer-readable medium described herein, transmitting one or more of the first feedback transmission or the second feedback transmission may include operations, features, means, or instructions for transmitting the first feedback transmission based on an initial decoding of the downlink transmission, the first feedback transmission indicating that the downlink transmission is successfully or unsuccessfully received at the UE, and transmitting the second feedback transmission based on a final decoding of the downlink transmission when the first feedback transmission indicates unsuccessful decoding of the downlink transmission.

In some examples of the method, apparatuses, and non-transitory computer-readable medium described herein, transmitting one or more of the first feedback transmission or the second feedback transmission may include operations, features, means, or instructions for transmitting the first feedback transmission based on an initial decoding of the downlink transmission, the first feedback transmission indicating that the downlink transmission is successfully or unsuccessfully received at the UE, and skipping the transmission of the second feedback transmission when the first feedback transmission indicates successful decoding of the downlink transmission.

In some examples of the method, apparatuses, and non-transitory computer-readable medium described herein, transmitting one or more of the first feedback transmission or the second feedback transmission further may include operations, features, means, or instructions for transmitting a channel quality indication with the first feedback transmission. In some examples of the method, apparatuses, and non-transitory computer-readable medium described herein, the channel quality indication provides a difference between a reference signal measurement of a reference signal provided with the downlink transmission and a prior reference signal measurement reported to the base station. In some examples of the method, apparatuses, and non-transitory computer-readable medium described herein, the first feedback transmission indicates successful or unsuccessful reception of the downlink transmission based on a value of the difference indicated in the channel quality indication. In some examples of the method, apparatuses, and non-transitory computer-readable medium described herein, a modulation and coding scheme (MCS) for a retransmission of the downlink transmission may be based on an initial MCS of the downlink transmission and the difference indicated in the channel quality indication.

In some examples of the method, apparatuses, and non-transitory computer-readable medium described herein, the downlink transmission may include operations, features, means, or instructions for multiplexing feedback information for the two or more concurrent downlink transmissions in one or more of the first feedback transmission or the second feedback transmission. In some examples of the method, apparatuses, and non-transitory computer-readable medium described herein, transmitting one or more of the first feedback transmission or the second feedback transmission further may include operations, features, means, or instructions for transmitting the first feedback transmission based at least in part on an initial decoding of one or more of the concurrent downlink transmissions indicating a NACK feedback of the associated downlink transmission at the UE. In some examples of the method, apparatuses, and non-transitory computer-readable medium described herein, the first feedback transmission includes one or more bits to indicate the NACK feedback for the one or more concurrent downlink transmissions. In some examples of the method, apparatuses, and non-transitory computer-readable medium described herein, transmitting one or more of the first feedback transmission or the second feedback transmission further may include operations, features, means, or instructions for determining that two or more of the concurrent downlink transmissions have NACK feedback, and selecting one of the two or more concurrent downlink transmissions that have the NACK feedback to report in the first feedback transmission based on a priority associated with each of the two or more concurrent downlink transmissions.

In some examples of the method, apparatuses, and non-transitory computer-readable medium described herein, multiplexing feedback information further may include operations, features, means, or instructions for multiplexing first feedback information for less than all of the two or more concurrent downlink transmissions in the first feedback transmission based on an initial decoding of the two or more concurrent downlink transmissions, and multiplexing second feedback information for each of the two or more concurrent downlink transmissions in the second feedback transmission based on a final decoding of the two or more concurrent downlink transmissions.

In some examples of the method, apparatuses, and non-transitory computer-readable medium described herein, multiplexing feedback information further may include operations, features, means, or instructions for multiplexing first feedback information for each of the two or more concurrent downlink transmissions in the first feedback transmission based on an initial decoding of the two or more concurrent downlink transmissions, and multiplexing second feedback information in the second feedback transmission only for concurrent downlink transmissions that had a NACK feedback in the first feedback transmission, where the second feedback information is based on a final decoding of associated downlink transmissions that had the NACK feedback.

Some examples of the method, apparatuses, and non-transitory computer-readable medium described herein may further include operations, features, means, or instructions for transmitting a capability indication to the base station that indicates a UE capability to transmit uplink feedback using one or more of the first set of uplink resources or the second set of uplink resources.

A method of wireless communication at a UE is described. The method may include transmitting a first uplink communication to a base station, receiving a retransmission grant from the base station that indicates that the first uplink communication is to be retransmitted to the base station, preparing a retransmission of the first uplink communication responsive to receiving the retransmission grant, monitoring for a cancellation indication from the base station that indicates the retransmission grant is canceled, and discontinuing preparation of the retransmission responsive to receiving the cancellation indication.

An apparatus for wireless communication at a UE is described. The apparatus may include a processor, memory in electronic communication with the processor, and instructions stored in the memory. The instructions may be executable by the processor to cause the apparatus to transmit a first uplink communication to a base station, receive a retransmission grant from the base station that indicates that the first uplink communication is to be retransmitted to the base station, prepare a retransmission of the first uplink communication responsive to receiving the retransmission grant, monitor for a cancellation indication from the base station that indicates the retransmission grant is canceled, and discontinue preparation of the retransmission responsive to receiving the cancellation indication.

Another apparatus for wireless communication at a UE is described. The apparatus may include means for transmitting a first uplink communication to a base station, receiving a retransmission grant from the base station that indicates that the first uplink communication is to be retransmitted to the base station, preparing a retransmission of the first uplink communication responsive to receiving the retransmission grant, monitoring for a cancellation indication from the base station that indicates the retransmission grant is canceled, and discontinuing preparation of the retransmission responsive to receiving the cancellation indication.

A non-transitory computer-readable medium storing code for wireless communication at a UE is described. The code may include instructions executable by a processor to transmit a first uplink communication to a base station, receive a retransmission grant from the base station that indicates that the first uplink communication is to be retransmitted to the base station, prepare a retransmission of the first uplink communication responsive to receiving the retransmission grant, monitor for a cancellation indication from the base station that indicates the retransmission grant is canceled, and discontinue preparation of the retransmission responsive to receiving the cancellation indication.

In some examples of the method, apparatuses, and non-transitory computer-readable medium described herein, the retransmission grant indicates that an initial reception of the uplink communication at the base station fails to meet a predetermined criteria. In some examples of the method, apparatuses, and non-transitory computer-readable medium described herein, receiving the retransmission grant may include operations, features, means, or instructions for receiving the retransmission grant in downlink resources that at least partially overlap in time with uplink resources used for transmitting the first uplink communication. Some examples of the method, apparatuses, and non-transitory computer-readable medium described herein may further include operations, features, means, or instructions for receiving the cancellation indication in a predetermined bit sequence or downlink control information from the base station.

Some examples of the method, apparatuses, and non-transitory computer-readable medium described herein may further include operations, features, means, or instructions for determining that a cancellation indication time period has expired prior to receipt of the cancellation indication, and transmitting the retransmission of the first uplink communication responsive to the expiration of the cancellation indication time period. In some examples of the method, apparatuses, and non-transitory computer-readable medium described herein, the cancellation indication time period corresponds to a preemption indication time period for the base station to preempt one or more uplink transmissions of one or more other UEs.

Some examples of the method, apparatuses, and non-transitory computer-readable medium described herein may further include operations, features, means, or instructions for transmitting a capability indication to the base station that indicates a UE capability to cancel the retransmission during a processing time for preparing the retransmission of the first uplink communication.

A method of wireless communication at a base station is described. The method may include identifying a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmitting a first downlink grant and the first downlink transmission to the UE, where the first downlink grant identifies the first set of downlink resources and one or more of the first set of uplink resources or the second set of uplink resources, monitoring for the first feedback transmission in the first set of uplink resources, and transmitting a second downlink grant that schedules a retransmission of the first downlink transmission to the UE based on the first feedback transmission indicating unsuccessful receipt of the first downlink transmission at the UE.

An apparatus for wireless communication at a base station is described. The apparatus may include a processor, memory in electronic communication with the processor, and instructions stored in the memory. The instructions may be executable by the processor to cause the apparatus to identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmit a first downlink grant and the first downlink transmission to the UE, where the first downlink grant identifies the first set of downlink resources and one or more of the first set of uplink resources or the second set of uplink resources, monitor for the first feedback transmission in the first set of uplink resources, and transmit a second downlink grant that schedules a retransmission of the first downlink transmission to the UE based on the first feedback transmission indicating unsuccessful receipt of the first downlink transmission at the UE.

Another apparatus for wireless communication at a base station is described. The apparatus may include means for identifying a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmitting a first downlink grant and the first downlink transmission to the UE, where the first downlink grant identifies the first set of downlink resources and one or more of the first set of uplink resources or the second set of uplink resources, monitoring for the first feedback transmission in the first set of uplink resources, and transmitting a second downlink grant that schedules a retransmission of the first downlink transmission to the UE based on the first feedback transmission indicating unsuccessful receipt of the first downlink transmission at the UE.

A non-transitory computer-readable medium storing code for wireless communication at a base station is described. The code may include instructions executable by a processor to identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmit a first downlink grant and the first downlink transmission to the UE, where the first downlink grant identifies the first set of downlink resources and one or more of the first set of uplink resources or the second set of uplink resources, monitor for the first feedback transmission in the first set of uplink resources, and transmit a second downlink grant that schedules a retransmission of the first downlink transmission to the UE based on the first feedback transmission indicating unsuccessful receipt of the first downlink transmission at the UE.

In some examples of the method, apparatuses, and non-transitory computer-readable medium described herein, the first feedback transmission indicates an ACK or NACK of the first downlink transmission based on an initial decoding of the first downlink transmission at the UE. In some examples of the method, apparatuses, and non-transitory computer-readable medium described herein, the second feedback transmission indicates ACK/NACK of the first downlink transmission based on the final decoding result of the first downlink transmission at the UE. In some examples of the method, apparatuses, and non-transitory computer-readable medium described herein, the initial decoding may be based on a received power of the first downlink transmission at the UE relative to a threshold value. In some examples of the method, apparatuses, and non-transitory computer-readable medium described herein, the received power may be measured based on a reference signal transmitted with the first downlink transmission.

In some examples of the method, apparatuses, and non-transitory computer-readable medium described herein, the initial decoding may be based on a first number of decoding iterations performed at the UE on the first downlink transmission, where the first number of decoding iterations may be less than a second number of decoding iterations to determine the final decoding result of the first downlink transmission.

In some examples of the method, apparatuses, and non-transitory computer-readable medium described herein, the first set of uplink resources at least partially overlaps in time with the first set of downlink resources. In some examples of the method, apparatuses, and non-transitory computer-readable medium described herein, the second downlink grant may be transmitted prior to a second starting time of the second set of uplink resources.

Some examples of the method, apparatuses, and non-transitory computer-readable medium described herein may further include operations, features, means, or instructions for transmitting a resource indicator with the first downlink grant that indicates the first set of uplink resources and the second set of uplink resources based on a mapping of uplink resource pairs to an index value of the resource indicator. Some examples of the method, apparatuses, and non-transitory computer-readable medium described herein may further include operations, features, means, or instructions for transmitting a first resource indicator and a second resource indicator with the first downlink grant, where the first resource indicator may be mapped to the first set of uplink resources, and the second resource indicator may be mapped to the second set of uplink resources. Some examples of the method, apparatuses, and non-transitory computer-readable medium described herein may further include operations, features, means, or instructions for transmitting a resource indicator with the first downlink grant that indicates the first set of uplink resources, and determining the second set of uplink resources based on a mapping between the first set of uplink resources and the second set of uplink resources.

Some examples of the method, apparatuses, and non-transitory computer-readable medium described herein may further include operations, features, means, or instructions for determining that the UE implicitly acknowledges the first downlink transmission based on the first feedback transmission being absent from the first set of uplink resources, and monitoring for the second feedback transmission in the second set of uplink resources for an explicit acknowledgment of the first downlink transmission.

Some examples of the method, apparatuses, and non-transitory computer-readable medium described herein may further include operations, features, means, or instructions for receiving the first feedback transmission indicating that the first downlink transmission is successfully or unsuccessfully received at the UE, and monitoring for the second feedback transmission only when the first feedback transmission indicates unsuccessful decoding of the first downlink transmission at the UE.

In some examples of the method, apparatuses, and non-transitory computer-readable medium described herein, the first feedback transmission includes a channel quality indication. In some examples of the method, apparatuses, and non-transitory computer-readable medium described herein, the channel quality indication provides a difference between a reference signal measurement at the UE of a reference signal provided with the first downlink transmission and a prior reference signal measurement reported by the UE. Some examples of the method, apparatuses, and non-transitory computer-readable medium described herein may further include operations, features, means, or instructions for determining whether the first feedback transmission indicates successful or unsuccessful reception of the first downlink transmission based on a value of the difference indicated in the channel quality indication. Some examples of the method, apparatuses, and non-transitory computer-readable medium described herein may further include operations, features, means, or instructions for determining a MCS for the retransmission of the first downlink transmission based on the difference indicated in the channel quality indication.

In some examples of the method, apparatuses, and non-transitory computer-readable medium described herein, the first downlink transmission may include operations, features, means, or instructions for monitoring for multiplexed feedback information for the two or more concurrent downlink transmissions in one or more of the first feedback transmission or the second feedback transmission. In some examples of the method, apparatuses, and non-transitory computer-readable medium described herein, the first feedback transmission indicates NACK feedback of one or more of the concurrent downlink transmissions at the UE. In some examples of the method, apparatuses, and non-transitory computer-readable medium described herein, the first feedback transmission includes one or more bits to indicate the NACK feedback for the one or more concurrent downlink transmissions. Some examples of the method, apparatuses, and non-transitory computer-readable medium described herein may further include operations, features, means, or instructions for, when two or more of the concurrent downlink transmissions have NACK feedback, the first feedback transmission indicates NACK feedback based on a priority associated with each of the two or more concurrent downlink transmissions.

In some examples of the method, apparatuses, and non-transitory computer-readable medium described herein, the first feedback transmission includes feedback information for less than all of the two or more concurrent downlink transmissions, and the second feedback transmission includes feedback information for each of the two or more concurrent downlink transmissions based on a final decoding of the two or more concurrent downlink transmissions at the UE. In some examples of the method, apparatuses, and non-transitory computer-readable medium described herein, the first feedback transmission includes feedback information for each of the two or more concurrent downlink transmissions, and the second feedback transmission includes feedback information only for concurrent downlink transmissions that had a NACK feedback in the first feedback transmission.

Some examples of the method, apparatuses, and non-transitory computer-readable medium described herein may further include operations, features, means, or instructions for receiving a capability indication from the UE that indicates a capability to transmit uplink feedback using one or more of the first set of uplink resources or the second set of uplink resources.

A method of wireless communication at a base station is described. The method may include transmitting a first uplink grant that includes first uplink resources for a first uplink communication from a UE, receiving the first uplink communication in the first uplink resources, transmitting a retransmission uplink grant to the UE to retransmit the first uplink communication based on an initial evaluation of the first uplink communication failing to meet a predetermined criteria, determining that a final decoding output results in a successful decoding of the first uplink communication, and transmitting a cancellation indication to the UE that indicates the retransmission uplink grant is canceled.

An apparatus for wireless communication at a base station is described. The apparatus may include a processor, memory in electronic communication with the processor, and instructions stored in the memory. The instructions may be executable by the processor to cause the apparatus to transmit a first uplink grant that includes first uplink resources for a first uplink communication from a UE, receive the first uplink communication in the first uplink resources, transmit a retransmission uplink grant to the UE to retransmit the first uplink communication based on an initial evaluation of the first uplink communication failing to meet a predetermined criteria, determine that a final decoding output results in a successful decoding of the first uplink communication, and transmit a cancellation indication to the UE that indicates the retransmission uplink grant is canceled.

Another apparatus for wireless communication at a base station is described. The apparatus may include means for transmitting a first uplink grant that includes first uplink resources for a first uplink communication from a UE, receiving the first uplink communication in the first uplink resources, transmitting a retransmission uplink grant to the UE to retransmit the first uplink communication based on an initial evaluation of the first uplink communication failing to meet a predetermined criteria, determining that a final decoding output results in a successful decoding of the first uplink communication, and transmitting a cancellation indication to the UE that indicates the retransmission uplink grant is canceled.

A non-transitory computer-readable medium storing code for wireless communication at a base station is described. The code may include instructions executable by a processor to transmit a first uplink grant that includes first uplink resources for a first uplink communication from a UE, receive the first uplink communication in the first uplink resources, transmit a retransmission uplink grant to the UE to retransmit the first uplink communication based on an initial evaluation of the first uplink communication failing to meet a predetermined criteria, determine that a final decoding output results in a successful decoding of the first uplink communication, and transmit a cancellation indication to the UE that indicates the retransmission uplink grant is canceled.

Some examples of the method, apparatuses, and non-transitory computer-readable medium described herein may further include operations, features, means, or instructions for performing the initial evaluation based on a first number of decoding iterations on the first uplink communication, where the first number of decoding iterations is less than a second number of decoding iterations to determine the final decoding output. Some examples of the method, apparatuses, and non-transitory computer-readable medium described herein may further include operations, features, means, or instructions for performing the initial evaluation based on a received power of the first uplink communication relative to a threshold value.

In some examples of the method, apparatuses, and non-transitory computer-readable medium described herein, the retransmission grant may be transmitted in downlink resources that at least partially overlap in time with the first uplink resources. In some examples of the method, apparatuses, and non-transitory computer-readable medium described herein, the cancellation indication may be transmitted using a predetermined bit sequence or downlink control information transmitted to the UE. In some examples of the method, apparatuses, and non-transitory computer-readable medium described herein, the cancellation indication may be provided in downlink time resources that correspond to time resources for a preemption indication that preempts one or more uplink transmissions of one or more other UEs, and where the preemption indication may be transmitted to the one or more other UEs when the final decoding output results in an unsuccessful decoding of the first uplink communication.

Some examples of the method, apparatuses, and non-transitory computer-readable medium described herein may further include operations, features, means, or instructions for receiving a capability indication from the UE that indicates a capability to cancel the retransmission uplink grant during a processing time for preparing a retransmission of the first uplink communication.

### BRIEF DESCRIPTION OF THE DRAWINGS

FIG. 1 illustrates an example of a system for wireless communications that supports acknowledgment feedback techniques in wireless communications in accordance with aspects of the present disclosure.

FIG. 2 illustrates an example of a wireless communications system that supports acknowledgment feedback techniques in wireless communications in accordance with aspects of the present disclosure.

FIG. 3 illustrates an example of a feedback timeline that supports acknowledgment feedback techniques in wireless communications in accordance with aspects of the present disclosure.

FIG. 4 illustrates another example of a feedback timeline that supports acknowledgment feedback techniques in wireless communications in accordance with aspects of the present disclosure.

FIG. 5 illustrates an example of a retransmission timeline that supports acknowledgment feedback techniques in wireless communications in accordance with aspects of the present disclosure.

FIGS. 6A through 6C illustrate examples of uplink resource indications that support acknowledgment feedback techniques in wireless communications in accordance with aspects of the present disclosure.

FIG. 7 illustrates an example of concurrent downlink transmissions that support acknowledgment feedback techniques in wireless communications in accordance with aspects of the present disclosure.

FIG. 8 illustrates an example of an uplink retransmission timeline that supports acknowledgment feedback techniques in wireless communications in accordance with aspects of the present disclosure.

FIG. 9 illustrates another example of an uplink retransmission timeline that supports acknowledgment feedback techniques in wireless communications in accordance with aspects of the present disclosure.

FIGS. 10 and 11 illustrate examples of process flows that support acknowledgment feedback techniques in wireless communications in accordance with aspects of the present disclosure.

FIGS. 12 and 13 show block diagrams of devices that support acknowledgment feedback techniques in wireless communications in accordance with aspects of the present disclosure.

FIG. 14 shows a block diagram of a communications manager that supports acknowledgment feedback techniques in wireless communications in accordance with aspects of the present disclosure.

FIG. 15 shows a diagram of a system including a device that supports acknowledgment feedback techniques in wireless communications in accordance with aspects of the present disclosure.

FIGS. 16 and 17 show block diagrams of devices that support acknowledgment feedback techniques in wireless communications in accordance with aspects of the present disclosure.

FIG. 18 shows a block diagram of a communications manager that supports acknowledgment feedback techniques in wireless communications in accordance with aspects of the present disclosure.

FIG. 19 shows a diagram of a system including a device that supports acknowledgment feedback techniques in wireless communications in accordance with aspects of the present disclosure.

FIGS. 20 through 25 show flowcharts illustrating methods that support acknowledgment feedback techniques in wireless communications in accordance with aspects of the present disclosure.

### DETAILED DESCRIPTION

Various aspects of the present disclosure provide for acknowledging receipt of a transmission based on an initial decoding or measurement of the transmission, which may trigger a relatively low latency retransmission. In some aspects of the disclosure, reduced latency feedback may be provided based on initial decoding or measurements of a transmission, which may allow for relatively fast retransmissions in cases where a transmission is not likely to be successfully received. In some cases, a user equipment (UE) may receive a downlink grant from a base station and may monitor associated downlink resources for a downlink transmission. The UE may perform initial decoding or a measurement on the downlink transmission and determine an initial feedback for the downlink transmission (e.g., an acknowledgment (ACK) or negative acknowledgment (NACK) feedback). In some cases, the UE may determine the initial feedback and may transmit the initial feedback to the base station in a first set of uplink resources configured for initial feedback transmissions. The UE may continue decoding operations to determine a final feedback in a second set of uplink resources configured for final feedback transmissions.

In cases where the UE transmits an initial feedback that indicates a NACK, the base station may receive the initial feedback and initiate a retransmission of the downlink transmission. In some cases, the base station may initiate the retransmission before a final feedback determination is made at the UE. In some cases, a reduced initial feedback processing timeline may be configured for initial feedback that is shorter than a final or regular feedback processing timeline. Such an initial feedback may provide a relatively low latency retransmission, which may help to reduce overall system latency and enhance reliability.

In some cases, the UE may receive an uplink grant from the base station and may transmit an uplink transmission using resources indicated in the uplink grant. The base station, in some cases, may perform initial decoding or a measurement on the uplink transmission and make an initial determination as to whether the uplink transmission is likely to be successfully received. In cases where the initial determination indicates an unsuccessful decoding of the uplink transmission is a likely outcome, the base station may transmit a second uplink grant for the UE to retransmit the uplink transmission. In some cases, the base station may complete one or more additional decoding iterations on the uplink transmission and determine that the transmission is successfully decoded, in which case the base station may transmit a cancellation indication to the UE to cancel the uplink retransmission.

Various techniques discussed herein may provide for relatively low latency feedback and retransmissions, which may enhance system performance in some situations. For example, in some cases a system may support different wireless services, such as services that use ultra-reliable low latency communications (URLLC) or services that use enhanced mobile broadband (eMBB), which may use acknowledgment feedback (e.g., hybrid acknowledgment repeat request (HARQ) acknowledgment/negative-acknowledgment (ACK/NACK) feedback) that is transmitted by a UE to acknowledge safe receipt of a transmission or to indicate unsuccessful receipt and/or decoding of the transmission to trigger a retransmission. Acknowledgment feedback for downlink transmissions by a UE may be transmitted after a processing timeline at the UE that allows for receipt and a number of decoding iterations of a received transmission to make a final determination as to whether the transmission is successfully received or not. Such a processing timeline may be referred to herein as a regular processing timeline that corresponds to a minimum processing time for the UE to determine and generate a regular feedback transmission (e.g., a minimum processing time of N1 symbols between a physical downlink shared channel (PDSCH) transmission and a physical uplink control channel (PUCCH) allocation for transmitting HARQ feedback). For uplink transmissions, a UE may have a processing timeline that provides a minimum time between receipt of an uplink grant and a start of an uplink transmission (e.g., a minimum processing time of N2 symbols between a physical downlink control channel (PDCCH) transmission with an uplink grant and a physical uplink shared channel (PUSCH) transmission).

In some cases, low latency services (e.g., services that use URLLC) may have relatively strict latency and reliability targets that may not permit a system to rely on retransmissions to achieve reliability targets based on regular processing timelines. Techniques such as discussed herein, in some cases, may allow for retransmissions based on initial decoding or measurements to occur within latency target timelines for low latency services, and may thus enhance system reliability and latency in such situations. In some cases, a base station operating in accordance with techniques provided herein may perform scheduling or configure transmission parameters that are less conservative than would otherwise be necessary if retransmissions were not able to be completed within low latency timelines. Allowing the base station to be more aggressive in scheduling or selecting transmission parameters (e.g., selecting a modulation and coding scheme (MCS) for transmissions that allows for scheduling of more UEs) may help to enhance overall system efficiency.

Aspects of the disclosure are initially described in the context of a wireless communications system. Various examples of feedback and retransmission timelines and associated resources are then discussed. Aspects of the disclosure are further illustrated by and described with reference to apparatus diagrams, system diagrams, and flowcharts that relate to acknowledgment feedback techniques in wireless communications.

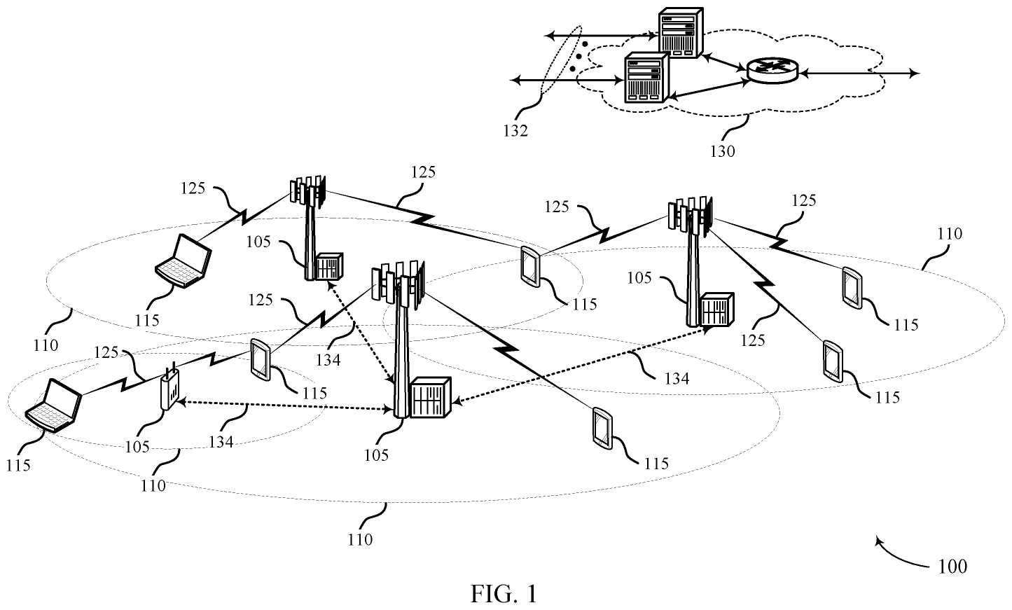

FIG. 1 illustrates an example of a wireless communications system 100 that supports acknowledgment feedback techniques in wireless communications in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use HARQ to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Ts=1/30,720,000 seconds. Time intervals of a communications resource may be organized according to radio frames each having a duration of 10 milliseconds (ms), where the frame period may be expressed as T_{f}=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, UEs 115 and base stations 105 may implement feedback and retransmission techniques that are based on initial determinations of received transmissions and thus allow for relatively fast feedback indications and retransmissions. In some cases, for downlink transmissions a base station 105 may configure multiple sets of uplink resources for transmission of ACK/NACK feedback from a UE 115. In some cases, a first set of uplink resources may be configured for an initial feedback determination by the UE 115 (e.g., based on a reduced number of decoding iterations or a measurement of either a reference signal transmitted with a downlink control channel (e.g., PDCCH) or a reference signal transmitted with a downlink data channel (e.g., PDSCH)), and a second set of uplink resources may be configured for a final feedback determination by the UE 115. In some cases, the initial feedback determination may have a shorter processing timeline than a regular processing timeline for the final feedback determination (e.g., the shorter timeline has N1′ slots and the regular processing timeline has N1 slots, where N1′<N1). A base station 105 that receives a NACK feedback in the first set of uplink resources may initiate a retransmission of the downlink transmission before the end of the regular processing timeline, in some cases.

In some cases, for an uplink transmission from a UE 115, a base station 105 may perform an initial determination of whether the uplink transmission is likely to be successfully received. In cases where the initial determination indicates that the uplink transmission is unlikely to be successfully received, the base station 105 may retransmit a grant with an allocation of uplink resources to the UE 115 for a retransmission. In the event that the uplink transmission is successfully decoded after the allocation of the uplink resources, the base station 105 may transmit a cancellation indication, and the UE 115 may cancel the retransmission.

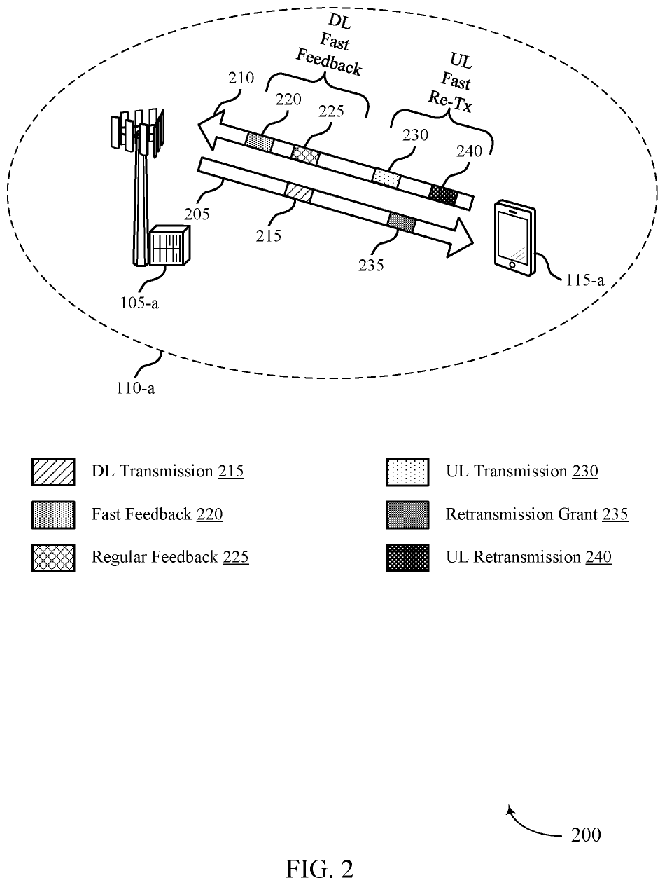

FIG. 2 illustrates an example of a wireless communications system 200 that supports acknowledgment feedback techniques in wireless communications in accordance with aspects of the present disclosure. In some examples, wireless communications system 200 may implement aspects of wireless communications system 100. The wireless communications system 200 may include base station 105-a and UE 115-a, which may be examples of the corresponding devices described with reference to FIG. 1. Base station 105-a may provide network coverage for a geographic coverage area 110-a. The base station 105-a may transmit downlink transmissions 210 to the UE 115-a, and the UE 115-a may transmit uplink communications 205 to the base station 105-a.

In some cases, the wireless communications system 200 (e.g., an NR system) may support fast acknowledgment feedback of a downlink transmission 215, in which uplink resources for transmitting the acknowledgment feedback may include a first set of uplink resources 220 for fast feedback, and a second set of uplink resources 225 for regular feedback. In such cases, the UE 115-a may perform initial decoding or a measurement on the downlink transmission 215 and determine an initial (or fast) feedback. For example, the UE 115-a may make an initial feedback determination based on a reduced number of decoding iterations and determine whether the downlink transmission 215 is likely to be successfully decoded (e.g., based on a difference between decoding iterations of a message passing algorithm that is less than a threshold value), or may measure a signal strength of either a reference signal transmitted with a downlink control channel or a reference signal transmitted with a downlink data channel in the downlink transmission 215 relative to a threshold value (e.g., a demodulation reference signal (DMRS) signal strength relative to a threshold value). The UE 115-a may transmit the initial feedback determination to the base station 105-a in the first set of uplink resources 220. In some examples, the UE 115-a may be enabled to use just the second set of uplink resources 225 for regular feedback. In other examples, the UE 115-a may be enabled to use both the first set of uplink resources 220 for fast feedback and the second set of uplink resources 225 for regular feedback. Enablement of the feedback mode may be determined from a radio resource control configuration message. In other cases, the UE 115-a may determine the feedback mode from a downlink grant that dynamically indicates whether the UE 115-a is to be operating in a fast feedback mode or a regular feedback mode. The dynamic indicator may be an explicit field in a downlink control information (DCI). Alternatively, the dynamic indicator may in the form of a DCI format. For example, a first DCI format may be used to trigger the fast feedback mode and a second DCI format may be used to trigger the regular feedback mode. Alternatively, a codepoint in an existing field in the DCI may be used to indicate that the UE 115-a does not need to perform in the fast feedback mode. In an example relating to the codepoint in the existing field in the DCI, if the DCI contains two PUCCH resource indicator (PRI) fields to indicate two PUCCH resources for the first and second feedback transmissions, then one codepoint for the first PRI may indicate that the UE 115-a does not need to perform in the fast feedback mode.

In some cases, the UE 115-a may complete decoding operations on the downlink transmission 215, determine a final feedback indication, and transmit the final feedback indication to the base station 105-a in the second set of uplink resources 220. In cases where the UE 115-a transmits an initial feedback that indicates a NACK, the base station 105-a may receive the initial feedback and make a relatively early scheduling decision to initiate a retransmission of the downlink transmission.

In some cases, the wireless communications system 200 may also support relatively fast retransmissions of an uplink transmission 230 (e.g., a PUSCH transmission) from the UE 115-a. In such cases, the UE 115-a may transmit the uplink transmission 230 using resources indicated in an uplink grant from the base station 105-a. The base station 105-a may perform initial decoding or a measurement on the uplink transmission 230 and make an initial determination as to whether the uplink transmission 230 is likely to be successfully received. In cases where the initial determination indicates an unsuccessful decoding of the uplink transmission 230, the base station 105-a may transmit a retransmission grant 235 for the UE 115-a to retransmit the uplink transmission. The UE 115-a may then transmit uplink retransmission 240. In some cases, the base station 105-a may complete one or more additional decoding iterations on the original uplink transmission 230 and determine that the transmission is successfully decoded, in which case the base station 105-a may transmit a cancellation indication to the UE 115-a to cancel the uplink retransmission 240. Such techniques may allow the UE 115-a to begin retransmission processing more quickly, and cancel the uplink retransmission 240 in the event of a cancellation indication, which may be performed in a relatively short timeline. Various examples of downlink feedback and retransmissions, and uplink fast retransmissions are discussed in more detail below.

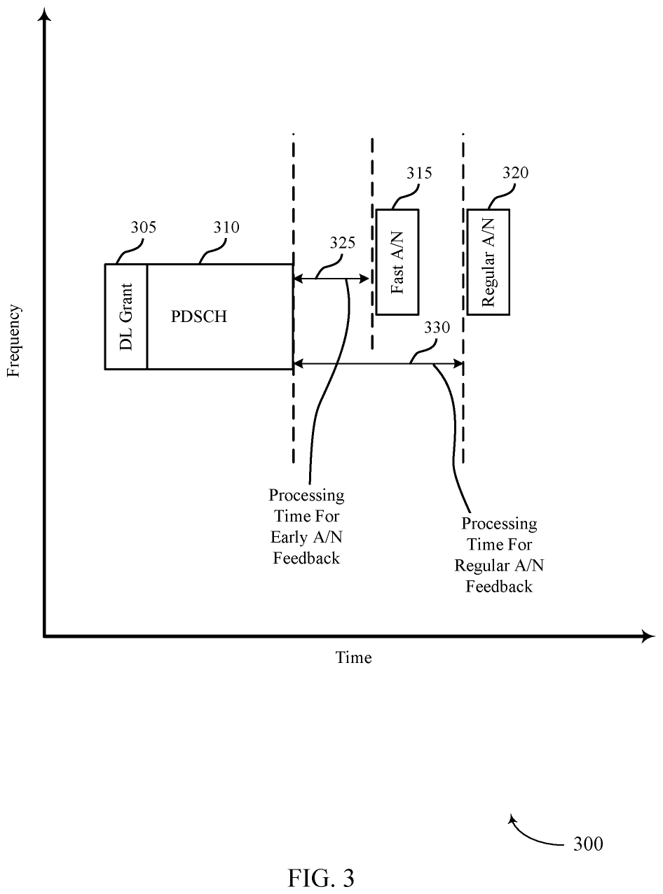

FIG. 3 illustrates an example of a feedback timeline 300 that supports acknowledgment feedback techniques in wireless communications in accordance with aspects of the present disclosure. In some examples, feedback timeline 300 may implement aspects of wireless communications system 100 or 200. In this example, feedback for downlink transmissions from a base station (e.g., a base station 105 of FIG. 1 or 2) may be provided by a UE (e.g., a UE 115 of FIG. 1 or 2) using one or both of two sets of uplink resources configured for feedback transmissions.

In this example, a downlink grant 305 may be provided by a base station and received at a UE. The downlink grant 305 may provide a resource allocation for a downlink PDSCH 310 transmission. In some cases, the downlink grant 305 may also provide an indication of multiple sets of uplink resources (e.g., PUCCH resources) for transmission of feedback (e.g., HARQ ACK/NACK feedback) to the base station that indicates whether the UE successfully or unsuccessfully received the PDSCH 310 transmission. In the example of FIG. 3, a first set of uplink resources 315 is provided for a fast feedback transmission (e.g., fast ACK/NACK feedback) that is based on an initial determination at the UE of successful or unsuccessful receipt of the PDSCH 310 transmission. In this case, a second set of uplink resources 320 may be provided for a regular feedback transmission (e.g., regular ACK/NACK feedback) that is based on a final determination at the UE of successful or unsuccessful receipt of the PDSCH 310 transmission. The first set of uplink resources 315 are earlier in time than the second set of uplink resources 320.

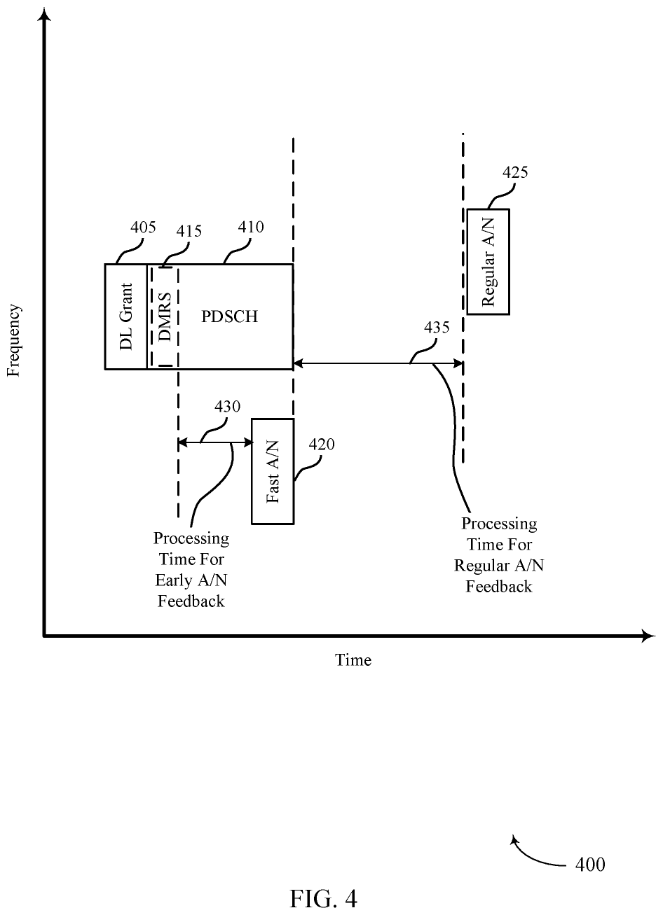

In the example of FIG. 3, a first processing time 325 may correspond to a time for the UE to perform processing of the fast feedback and preparation of the corresponding transmission using the first set of uplink resources 315. Further, a second processing time 330 may correspond to a time for the UE to perform processing of the regular feedback and preparation of the corresponding transmission using the second set of uplink resources 315. In some examples, the second processing time is longer than the first processing time (e.g., due to decoding or additional decoding iterations associated with the regular feedback transmission). The second processing time may, in some cases, correspond to a defined number of symbols, N1, that provide a minimum processing time between the PDSCH 310 and the second set of uplink resources 320 for the UE to perform full decoding of the PDSCH 310 and generate the regular feedback transmission. The first processing time 325 may correspond to a reduced timeline that may correspond to N1′ symbols, where N1′<N1. In some cases, as will be discussed in further detail with reference to FIG. 4, the first processing time 325 may allow for fast feedback resources to overlap in time with PDSCH 310.

A UE, in some cases, may determine the fast feedback based on a power detection (e.g., on a measured DMRS strength) or a data decoding of the PDSCH 310 with fewer decoding iterations than used for regular feedback. The base station that is serving the UE may use the fast feedback information from the UE to help make an early scheduling decision for a retransmission (e.g., in case of NACK provided with the fast feedback).

In some cases, the UE may transmit only the fast feedback using the first set of uplink resources 315 if the initial determination result is a NACK. In such cases, if the initial determination indicates an ACK feedback (e.g., if initial decoding iterations show a high confidence of successful decoding or a signal strength measurement is above a threshold value), the UE may not send the fast feedback. In such cases, the base station may assume an ACK if the fast feedback is not received from the UE. In such cases, the UE may transmit the regular feedback with the final decoding result using the second set of uplink resources 320. In some cases, such a technique may be used when energy detection is used for the initial determination of the fast feedback.

In some cases, the UE may always transmit the fast feedback using the first set of uplink resources 315 (e.g., ACK is transmitted if initial decoding is successful; NACK otherwise). In such cases, if the fast feedback is a NACK, the regular feedback may be transmitted in the second set of uplink resources 320 to confirm the final decoding result. In cases where the fast feedback is an ACK, the UE may optionally skip transmitting the regular feedback in the second set of uplink resources 320. In some cases, such techniques may be used when the initial feedback determination is based on relatively few decoding iterations.

In some cases, additionally or alternatively to the fast feedback indication, the UE may feedback a channel quality indicator (CQI), such as a “delta CQI,” to indicate the channel quality (e.g., based on a received DMRS in the PDSCH 310) on the first set of uplink resources 315. This CQI information may be used by the base station to schedule a retransmission, as well as for subsequent new transmissions. In some cases, the delta CQI may be an indication of a difference between a current measurement of a reference signal provided in the PDSCH 310 and a prior reference signal measurement. In some cases, the delta CQI may be transmitted only along with the fast feedback indication in the first set of uplink resources 315, and not with regular feedback in the second set of uplink resources 320.

In some cases, the fast feedback may not include an indication of ACK/NACK, and may instead include only an indication of delta CQI. In such cases, the base station may implicitly infer ACK or NACK for the fast feedback from the delta CQI. In some examples, the base station may make such an inference by determining a new CQI (CQI_new) as the overall CQI of the fading channel compared with the previous prediction used for scheduling the PDSCH 310 (e.g., CQI_new=CQI−delta CQI). In the event that delta CQI>0, the base station may infer a NACK, and that a retransmission grant is needed. Likewise, if delta CQI≤0, the base station may infer ACK, determine that retransmission is not needed, and apply CQI_new to subsequent PUSCH transmissions.

In other examples, delta CQI may be used to indicate the MCS used for retransmission only, and not be applied to subsequent first transmissions of different uplink packets. In such cases, the base station may adjust the retransmission MCS based on the delta CQI (e.g., retransmission MCS=MCS−delta_CQI), and the delta CQI may be either negative or positive. The base station may schedule the retransmission either based on the presence of the delta CQI or based on the regular feedback in cases where the UE may not feedback delta CQI if initial decoding is a successful decoding.

FIG. 4 illustrates an example of a feedback timeline 400 that supports acknowledgment feedback techniques in wireless communications in accordance with aspects of the present disclosure. In some examples, feedback timeline 400 may implement aspects of wireless communications system 100 or 200. In this example, feedback for downlink transmissions from a base station (e.g., a base station 105 of FIG. 1 or 2) may be provided by a UE (e.g., a UE 115 of FIG. 1 or 2) using one or both of two sets of uplink resources configured for feedback transmissions.

In this example, a downlink grant 405 may be provided by a base station and received at a UE. The downlink grant 405 may provide a resource allocation for a downlink PDSCH 410 transmission. In some cases, the downlink grant 405 may also provide an indication of multiple sets of uplink resources (e.g., PUCCH resources) for transmission of feedback (e.g., HARQ ACK/NACK feedback) to the base station that indicates whether the UE successfully or unsuccessfully received the PDSCH 410 transmission. In the example of FIG. 4, a first set of uplink resources 420 is provided for a fast feedback transmission (e.g., fast ACK/NACK feedback) that is based on an initial determination at the UE of successful or unsuccessful receipt of the PDSCH 410 transmission. In this case, a second set of uplink resources 425 may be provided for a regular feedback transmission (e.g., regular ACK/NACK feedback) that is based on a final determination at the UE of successful or unsuccessful receipt of the PDSCH 410 transmission.

In this example, the first set of uplink resources 420 are earlier in time than the second set of uplink resources 425, and overlap in time with at least a portion of the PDSCH 410 resources. In this example, the UE may make an initial determination for the fast feedback based on a reference signal measurement of a DMRS 415 transmitted with the PDSCH 410. In this case, a first processing time 430 may correspond to a time for the UE to perform processing of the fast feedback and preparation of the corresponding transmission using the first set of uplink resources 420, where the initial determination may be completed after the DMRS 415 and before an end time of the PDSCH 410. The second processing time 435 may correspond to a time for the UE to perform processing of the regular feedback and preparation of the corresponding transmission using the second set of uplink resources 425 in accordance with regular feedback timelines. Such early indication of fast feedback may allow the base station to make even earlier decisions of retransmissions of the PDSCH 410.

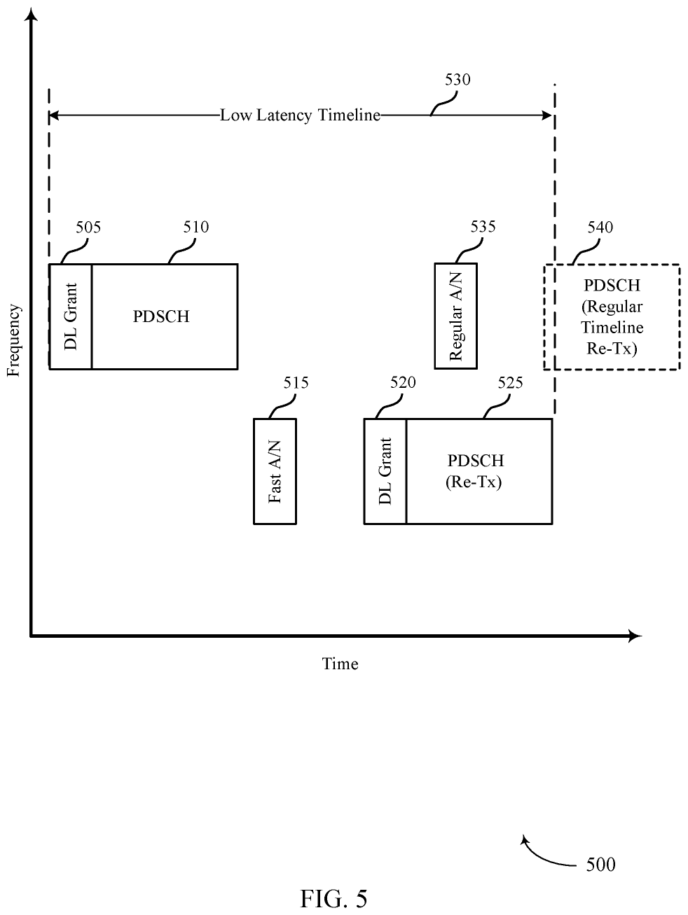

FIG. 5 illustrates an example of a retransmission timeline 500 that supports acknowledgment feedback techniques in wireless communications in accordance with aspects of the present disclosure. In some examples, retransmission timeline 500 may implement aspects of wireless communications system 100 or 200. In this example, feedback for downlink transmissions from a base station (e.g., a base station 105 of FIG. 1 or 2) may be provided by a UE (e.g., a UE 115 of FIG. 1 or 2) using one or both of two sets of uplink resources configured for feedback transmissions, and the base station may retransmit based on an early NACK indication.

In this example, a downlink grant 505 may be provided by a base station and received at a UE. The downlink grant 505 may provide a resource allocation for a downlink PDSCH 510 transmission. In some cases, the downlink grant 505 may also provide an indication of multiple sets of uplink resources (e.g., PUCCH resources) for transmission of feedback (e.g., HARQ ACK/NACK feedback) to the base station that indicates whether the UE successfully or unsuccessfully received the PDSCH 510 transmission. In the example of FIG. 5, a first set of uplink resources 515 is provided for a fast feedback transmission (e.g., fast ACK/NACK feedback) that is based on an initial determination at the UE of successful or unsuccessful receipt of the PDSCH 510 transmission. In this case, a second set of uplink resources 535 may be provided for a regular feedback transmission (e.g., regular ACK/NACK feedback) that is based on a final determination at the UE of successful or unsuccessful receipt of the PDSCH 510 transmission.

In this example, the UE may transmit a NACK in the fast feedback using the first set of uplink resources 515. Based on the early NACK indication, the base station may schedule a retransmission and transmit a retransmission downlink grant 520 to the UE, followed by a retransmission PDSCH 525. In this example, the retransmission downlink grant 520 and the retransmission PDSCH 525 may both start prior to the start of the second set of uplink resources 535. Such technique may allow the base station to perform the retransmission within a low latency timeline 530, and before an earliest PDSCH 540 that would otherwise be possible based on using only the regular feedback transmitted in the second set of uplink resources 535. Thus, in this example, only one downlink shared channel transmission would be possible within the low latency timeline 530 if the regular feedback transmission were used. However, with the fast feedback providing an earlier indication of a NACK, the base station may, in some cases, be able to accommodate the retransmission PDSCH 525 before expiration of the low latency timeline 530. In such cases, the base station may transmit the first PDSCH 510 transmission using less conservative transmission parameters that would be used if only a single transmission is possible (e.g., the base station may adjust margin for fast fading to provide more aggressive transmission parameters), which may enhance the overall system efficiency.

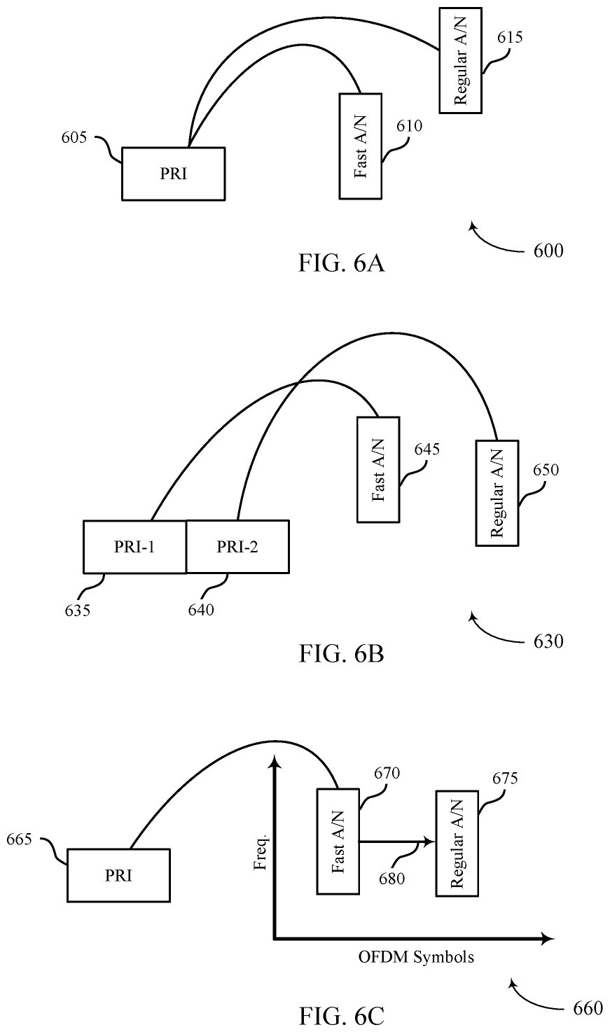

FIGS. 6A through 6C illustrate examples of uplink resource indications that support acknowledgment feedback techniques in wireless communications in accordance with aspects of the present disclosure. In some examples, uplink resource indications 600 may implement aspects of wireless communications system 100 or 200. In some cases, uplink resources for the feedback transmissions from a UE may be provided through a PUCCH resource indicator (PRI) that may be provided with a downlink grant.

In some cases, such as illustrated in the example 600 of FIG. 6A, a single PRI 605 may be provided that indicates both a first set of uplink resources 610 for a fast ACK/NACK feedback, and a second set of uplink resources 615 for a regular ACK/NACK feedback. In some cases, a UE may be configured with a list of pairs of PUCCH resources, and each pair contains includes a unique first set of uplink resources 610 and second set of uplink resources 615. In some cases, a set of index values may be mapped to different pairs or resources, and the PRI 605 may provide an index value from the set of index values to indicate to the UE which pair of uplink resources are configured for the fast ACK/NACK and regular ACK/NACK transmissions.

In other cases, such as illustrated in the example 630 of FIG. 6B, the downlink grant may include a first PRI 635 and a second PRI 640 that point to separate uplink resources. In this example, the first PRI 635 may provide an index value that is mapped to the first set of uplink resources 645 for fast ACK/NACK feedback, and the second PRI 640 may provide an index value that is mapped to the second set of uplink resources 650 for regular ACK/NACK feedback.

In other cases, such as illustrated in the example 660 of FIG. 6C, the downlink grant may include a single PRI 665 that points to a first set of uplink resources 670 for fast ACK/NACK feedback. In this example, a fixed timing delta 680 (e.g., a configured number of symbols via RRC configuration), may provide a timing for the second set of uplink resources 675 for regular ACK/NACK feedback. In such cases, the UE may implicitly derive the second set of uplink resources 675 resource based on the first set of uplink resources 670 and the fixed timing delta 680 (e.g., half a slot).

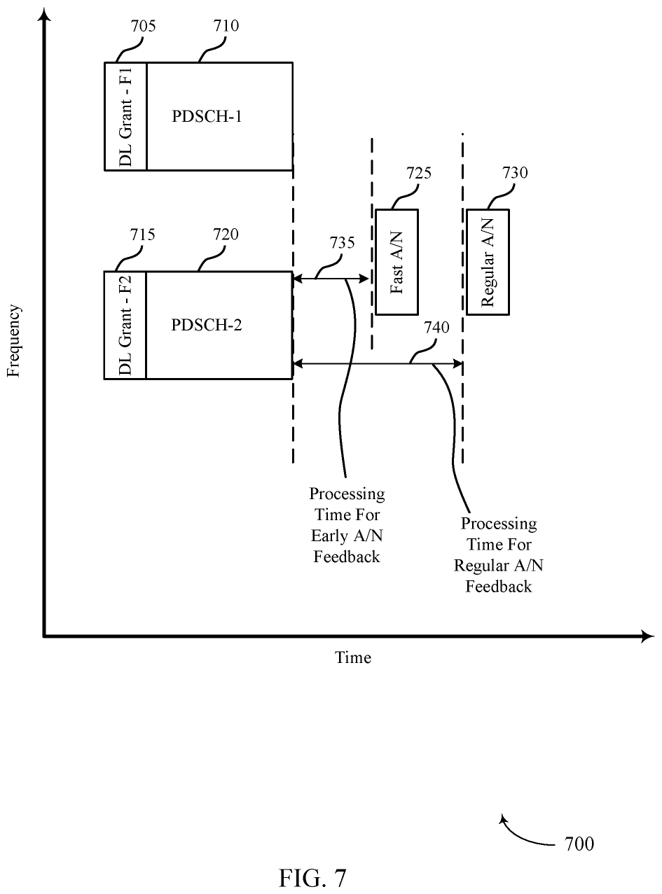

FIG. 7 illustrates an example of concurrent transmissions 700 that supports acknowledgment feedback techniques in wireless communications in accordance with aspects of the present disclosure. In some examples, concurrent transmissions 700 may implement aspects of wireless communications system 100 or 200. In some cases, a base station may transmit multiple concurrent downlink transmissions to a UE (e.g., using multiple component carriers). In the example of FIG. 7, a base station may transmit a first downlink grant 705 for a first concurrent PDSCH 710 transmission and a second downlink grant 715 for a second concurrent PDSCH 720 transmission.

In such a case, the receiving UE may provide a multi-bit ACK/NACK feedback. In some cases, one or both downlink grants 710, 715, may provide an indication of a first set of uplink resources 725 for a fast feedback transmission, and a second set of uplink resources 730 for a regular feedback transmission. Similarly as discussed above, a first processing timeline 735 may be configured for the fast feedback transmission, and a second processing timeline 740 may be configured for the regular feedback transmission. In some cases, the UE may multiplex the fast feedback for the first concurrent PDSCH 710 and the second concurrent PDSCH 720, and any other additional concurrent PDSCH transmissions, and transmit the multiplexed fast feedback using the first set of uplink resources 725. The UE may also multiplex the regular feedback for the first concurrent PDSCH 710 and the second concurrent PDSCH 720, and any other additional concurrent PDSCH transmissions, and transmit the multiplexed regular feedback using the second set of uplink resources 730.

In some cases, the fast feedback may be transmitted only if the initial decoding results for at least one PDSCH is a NACK (e.g., the fast feedback contains ┌log₂ K┐ bits, where K denotes the number of PDSCHs scheduled and ┌x┐ denotes the ceiling operation, which is equal to the smallest integer that is greater than or equal to x), Thus, UE will indicate to the base station a particular PDSCH whose initial decoding result is NACK. In some cases, the UE may determine which PDSCH to NACK (e.g., in cases where more than one PDSCH has initial decoding results of NACK) based on one or more of a priority or latency of the corresponding PDSCH. In such cases, the regular feedback may contain the final decoding results of all PDSCHs. In other cases, the fast feedback may include initial decoding results of all PDSCHs, and the regular feedback may be optionally skipped only if all PDSCHs are correctly decoded in the initial decoding phase (i.e., the fast feedback indicates all ACKs). The base station may make scheduling determinations for any retransmissions in a similar manner as discussed with respect to FIGS. 2 through 6.

In some cases, uplink resources for the feedback transmissions of the multiple concurrent transmissions may be provided through a PRI in one or more of the downlink grants 705 or 715, using similar techniques as discussed wire respect to FIGS. 6A through 6C. In some cases, a PM may be provided with each downlink grant and the UE thus receives multiple PM fields in the multiple downlink grants. In such cases, the UE may determine the first set of uplink resources 725 and the second set of uplink resources 730 based on a PRI of one of the received downlink grant in accordance with a defined ordering. In some cases, the defined ordering of the multiple downlink grants for determination of the PRI may provide, for example, that PM is first ordered based on the starting time of a PDCCH monitoring occasion that includes the downlink grant (e.g., a PM received in the latest downlink grant is used to determine feedback resources). The PM may then be ordered, in cases where a same PDCCH monitoring occasion includes multiple downlink grants (e.g., as illustrated in FIG. 7), based on a component carrier index or serving cell index (e.g., a PRI received in a lowest component carrier index or serving cell index is used to determine feedback resources).

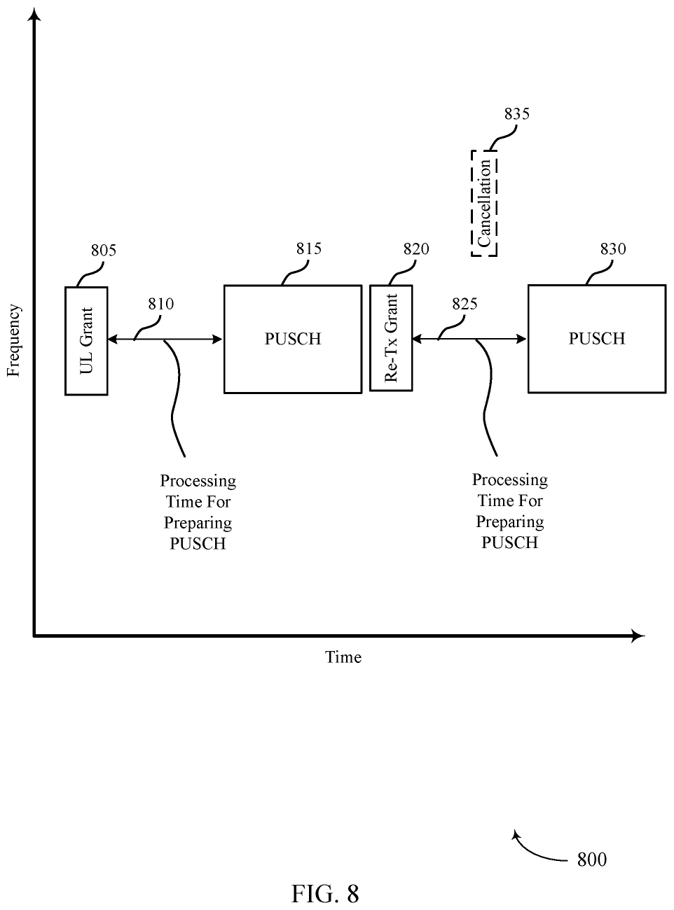

FIG. 8 illustrates an example of an uplink retransmission timeline 800 that supports acknowledgment feedback techniques in the uplink of wireless communications in accordance with aspects of the present disclosure. In some examples, uplink retransmission timeline 800 may implement aspects of wireless communications system 100 or 200. In this example, a retransmission of an uplink transmission from a UE (e.g., a UE 115 of FIG. 1 or 2) may be scheduled by a base station (e.g., a base station 105 of FIG. 1 or 2) based on an initial decoding determination of the uplink transmission.

In this example, an uplink grant 805 may be provided by a base station and received at a UE. The uplink grant 805 may provide a resource allocation for an uplink PUSCH 815 transmission that starts after a minimum uplink processing time 810 for the UE to prepare a PUSCH after receiving the uplink grant 805 (e.g., N2 OFDM symbols). In this example, the base station may receive the PUSCH 815 and perform an initial determination of whether successful decoding of the PUSCH 815 is likely. If the initial determination indicates that the base station is likely to successfully decode the PUSCH 815, further decoding may be performed and a regular feedback transmission may be transmitted to the UE.

In other cases, such as illustrated in FIG. 8, the base station may determine that it is unlikely to successfully decode the PUSCH 815 after the initial determination, and may preemptively transmit a retransmission grant 820 to the UE to retransmit the PUSCH 815. The retransmission grant 820 may provide a resource allocation for an uplink PUSCH retransmission 830 that starts after uplink processing time 825 for the UE to prepare a PUSCH after receiving the uplink grant 820, where the uplink processing time 825 is at least as long as the minimum uplink processing time for the UE to prepare a PUSCH (e.g., N2 OFDM symbols). After transmitting the retransmission grant 820, the base station may continue to attempt to decode the first PUSCH 815 transmission, and in some cases may successfully decode the transmission. In such cases, the base station may transmit a cancellation indication 835 to the UE. The UE may receive the cancellation indication 835, and cancel the PUSCH retransmission 830. In such cases, the retransmission grant 820 may imply that the initial decoding of the uplink PUSCH 815 transmission was not successful (i.e., NACK), and the cancellation indication 835 may imply that the final decoding for the uplink PUSCH was successful (i.e., ACK).

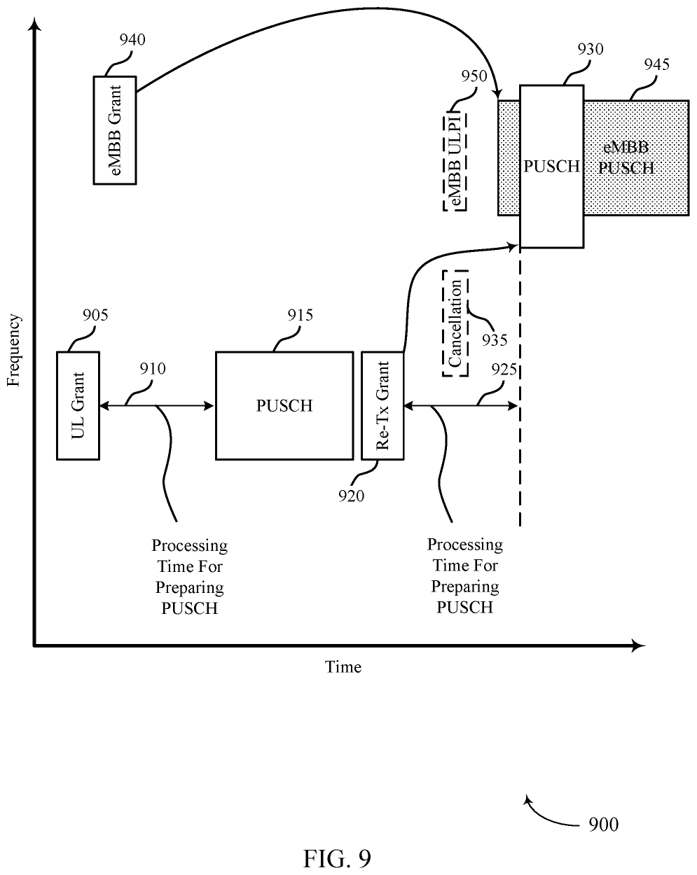

While the example of FIG. 8 shows the retransmission grant 820 after the PUSCH 815 transmission, other examples may provide that the retransmission grant 820 at least partially overlaps in time with the PUSCH 815 resources. The initial determination at the base station may be made using similar techniques as discussed for fast feedback in the examples for downlink transmissions, such as an energy or signal strength measurement of a reference signal provided in the uplink transmission, an initial number of decoding iterations, and the like. In some cases, the cancellation indication 835 may be provided in a predetermined sequence, or a PDCCH carrying downlink control information, for example. In some cases, the cancellation indication 835 may correspond in time to the timing for the base station to transmit a preemption indicator to one or more other UEs. An example of such a case is illustrated in FIG. 9.

FIG. 9 illustrates an example of a uplink retransmission timeline 900 that supports acknowledgment feedback techniques in wireless communications in accordance with aspects of the present disclosure. In some examples, uplink retransmission timeline 900 may implement aspects of wireless communications system 100 or 200. In this example, again a retransmission of an uplink transmission from a UE (e.g., a UE 115 of FIG. 1 or 2) may be scheduled by a base station (e.g., a base station 105 of FIG. 1 or 2) based on an initial decoding determination of the uplink transmission.

In this example, an uplink grant 905 may be provided by a base station and received at a UE. The uplink grant 905 may provide a resource allocation for an uplink PUSCH 915 transmission that starts after a minimum uplink processing time 910 for the UE to prepare a PUSCH after receiving the uplink grant 905 (e.g., N2 OFDM symbols). In this example, the base station may receive the PUSCH 915 and perform an initial determination of whether successful decoding of the PUSCH 915 is likely. If the initial determination indicates that the base station is likely to successfully decode the PUSCH 915, further decoding may be performed and a regular feedback transmission may be transmitted to the UE.

In other cases, such as illustrated in FIG. 9, the base station may determine that it is unlikely to successfully decode the PUSCH 915 after the initial determination, and may preemptively transmit a retransmission grant 920 to the UE to retransmit the PUSCH 915. The retransmission grant 920 may provide a resource allocation for an uplink PUSCH retransmission 930 that starts after uplink processing time 925 for the UE to prepare a PUSCH after receiving the uplink grant 920. After transmitting the retransmission grant 920, the base station may continue to attempt to decode the first PUSCH 915 transmission, and in some cases may successfully decode the transmission. In such cases, the base station may transmit a cancellation indication 935 to the UE. The UE may receive the cancellation indication 935, and cancel the PUSCH retransmission 930.

In the example of FIG. 9, the base station may also serve one or more other UEs, such as one or more UEs that transmit and receive data traffic using an enhanced mobile broadband (eMBB) service that may have more relaxed latency and reliability targets. In such cases, the base station may transmit an eMBB grant 940 to an eMBB UE, that indicates uplink resources for an eMBB PUSCH 945 transmission. In some cases, eMBB UEs may be configured to monitor for an uplink preemption indication (ULPI), that may indicate to the eMBB UE that all or a portion of a resource allocation of the eMBB UE is being preempted. Such preemption may occur, for example, if a higher priority UE or service, such as a URLLC UE, needs to be scheduled for a transmission that overlaps with the eMBB resource allocation. In this example, an eMBB ULPI 950 resource may be configured such that the uplink PUSCH retransmission 930 may preempt a portion of the eMBB PUSCH 945. A timing of the cancellation indication 935 and the eMBB ULPI 950 may be aligned, such that the base station may transmit either the cancellation indication 935, thus allowing the non-preempted eMBB PUSCH 945 to be transmitted in its entirety, or the base station may transmit a preemption indication in the eMBB ULPI 950 (and not cancellation indication 935), thus preempting the eMBB PUSCH 945 in favor of the uplink PUSCH retransmission 930. Such techniques may allow a base station in a highly loaded system with both URLLC and eMBB UEs to use ULPI to reclaim a pre-allocated eMBB resource to an URLLC UE.

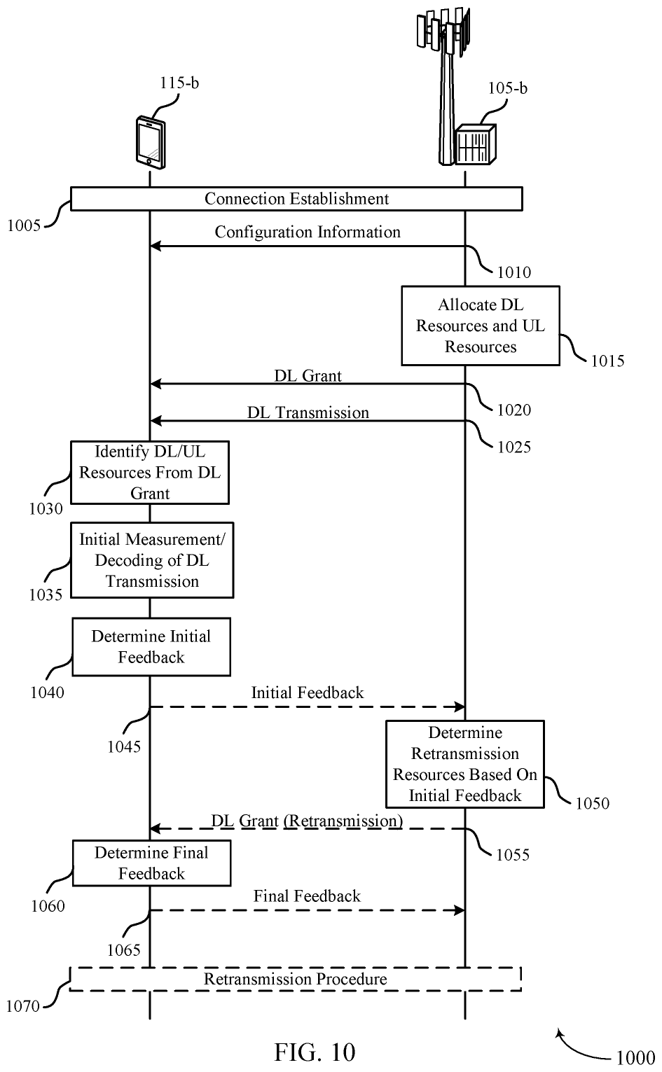

FIG. 10 illustrates an example of a process flow 1000 that supports acknowledgment feedback techniques in wireless communications in accordance with aspects of the present disclosure. In some examples, process flow 1000 may implement aspects of wireless communications system 100 or 200. The process flow 1000 may include base station 105-b and UE 115-b, which may be examples of the corresponding devices described with reference to FIGS. 1 through 9. Base station 105-b and UE 115-b may implement one or more techniques for acknowledgment feedback as discussed herein. Alternative examples of the following may be implemented, where some steps are performed in a different order than described or are not performed at all. In some cases, steps may include additional features not mentioned below, or further steps may be added.

At 1005, the UE 115-b and base station 105-b may perform a connection establishment that provides a communications link. The connection establishment may be performed according to established connection establishment techniques, such as through RRC signaling. In some cases, as part of the connection establishment, the UE may provide an indication of a capability to perform fast ACK/NACK feedback (e.g., via UE capability signaling). The base station 105-b, based on the indicated capability, may determine to configure the UE for fast feedback. In some cases, the base station 105-b may determine to configure fast feedback based on one or more system conditions, system loading, channel conditions at the UE 115-b, or any combinations thereof.

At 1010, the base station 105-b may transmit configuration information to the UE 115-b. In some cases, the configuration information may indicate that the UE 115-b and base station 105-b may use fast feedback in conjunction with regular feedback to provide retransmissions of downlink data communications according to a reduced timeline. In some cases, the configuration information may include information on a mapping between a PM and uplink control channel resources for uplink feedback transmissions. In some cases, the mapping of the PRI may provide a mapping to a pair of uplink resources for each PRI indicator value. In some cases, the configuration information may include a time and/or frequency offset between a first set of uplink resources for fast feedback transmissions and a second set of uplink resources for regular feedback transmissions.

At 1015, the base station 105-b may allocate downlink resources and uplink resources for communications with the UE 115-b. In some cases, the downlink resources may include PDSCH resources for a downlink data transmission to the UE 115-b. In some cases, the uplink resources may include a first set of uplink resources that are configured for fast feedback transmissions from the UE 115-b, and a second set of uplink resources that are configured for regular feedback transmissions from the UE 115-b.

At 1020, the base station 105-b may transmit a downlink grant to the UE 115-b. In some cases, the downlink grant may include an indication of the downlink resources and uplink resources allocated to the UE 115-b. The downlink grant may be transmitted in a PDCCH transmission to the UE 115-b.

At 1025, the base station 105-b may transmit downlink transmission to the UE 115-b. In some cases, the downlink transmission may be transmitted in a PUSCH transmission to the UE 115-b. The downlink transmission may include, in some cases, high priority data, or low latency data, according to a high reliability and low latency service (e.g., data of a URLLC service).

At 1030, the UE 115-b may identify the downlink resources and the uplink resources based on the downlink grant. In some cases, the UE 115-b may determine that an initial feedback determination is to be made for the downlink transmission (e.g., based on a service type indicated in the downlink grant). In some cases, the UE 115-b may determine that an initial feedback determination is to be made based on the uplink resources including a first set of uplink resources and a second set of uplink resources. In some cases, both the first and second set of uplink resources can be identified based on the DL grant (e.g., explicitly indicated, mapped pairs of resources that are indicated by an index value of a PM, an offset between the first set of uplink resources and the second set of uplink resources, or any combinations thereof).

At 1035, the UE 115-b may determine an initial measurement or perform initial decoding of the downlink transmission. In some cases, the UE 115-b may perform an initial measurement based on a reference signal received power (RSRP) of a DMRS provided with the downlink transmission. In other cases, the initial measurement may be based on one or more of a RSRP, reference signal received quality (RSRQ), signal to noise ratio (SNR) of the DMRS, a signal to interference and noise ratio (SINR) of the DMRS, or any combinations thereof. In some cases, the UE 115-b may perform an initial number of decoding iterations on the received downlink transmissions and may make a determination based on the initial number of decoding iterations of whether successful decoding is likely or unlikely.

At 1040, the UE 115-b may determine an initial feedback to be transmitted to the base station 105-b. In some cases, the initial feedback may be fast feedback that is based at least in part on the initial measurement or decoding performed on the downlink transmission. In some cases, the initial feedback may be determined based on whether the initial measurement or decoding indicates whether successful or unsuccessful decoding of the downlink transmission is likely. In some cases, the UE 115-b may determine to transmit the initial feedback only in cases where the initial determination indicates unsuccessful decoding of the downlink transmission. In other cases, the UE 115-b may determine to transmit the initial feedback that indicates either ACK or NACK based on the initial determination.

At 1045, the UE 115-b may transmit the initial feedback to the base station, in cases where it is determined to transmit the initial feedback. In some cases, the initial feedback may be transmitted in the first set of uplink resources.

At 1050, the base station may monitor for the initial feedback and determine retransmission resources based on the initial feedback. In cases where the base station 105-b receives initial feedback, and the initial feedback indicates unsuccessful receipt (NACK) of the downlink transmission, the base station may allocate retransmission resources. In cases where the base station 105-b does not receive initial feedback from the UE 115-b, or receives only ACK feedback, the base station 105-b may determine that retransmission resources are not needed.

At 1055, the base station 105-b may transmit a retransmission downlink grant to the UE 115-b, followed by a retransmission of the downlink transmission in accordance with a retransmission procedure 1070. In some cases, the retransmission downlink grant may not be transmitted, where the UE 115-b has indicated ACK only in the initial feedback, or does not transmit the initial feedback at all. It is noted that such a retransmission grant transmission, and associated retransmission, may occur before, during, or after the determination and transmission of the final feedback.

At 1060, the UE 115-b may determine a final feedback for the downlink transmission. In some cases, the final feedback may be determined based on a full decoding process of the downlink transmission (e.g., decoding iterations performed until convergence on the downlink transmission, and a cyclic redundancy check passes). In some cases, the UE 115-b may transmit the final feedback to the base station 105-b only when an initial feedback was not transmitted, or when the final feedback is different than the initial feedback. At 1065, the UE 115-b may transmit the final feedback to the base station 105-b, if it is determined to transmit the final feedback. The final feedback may be transmitted on the second set of uplink resources.

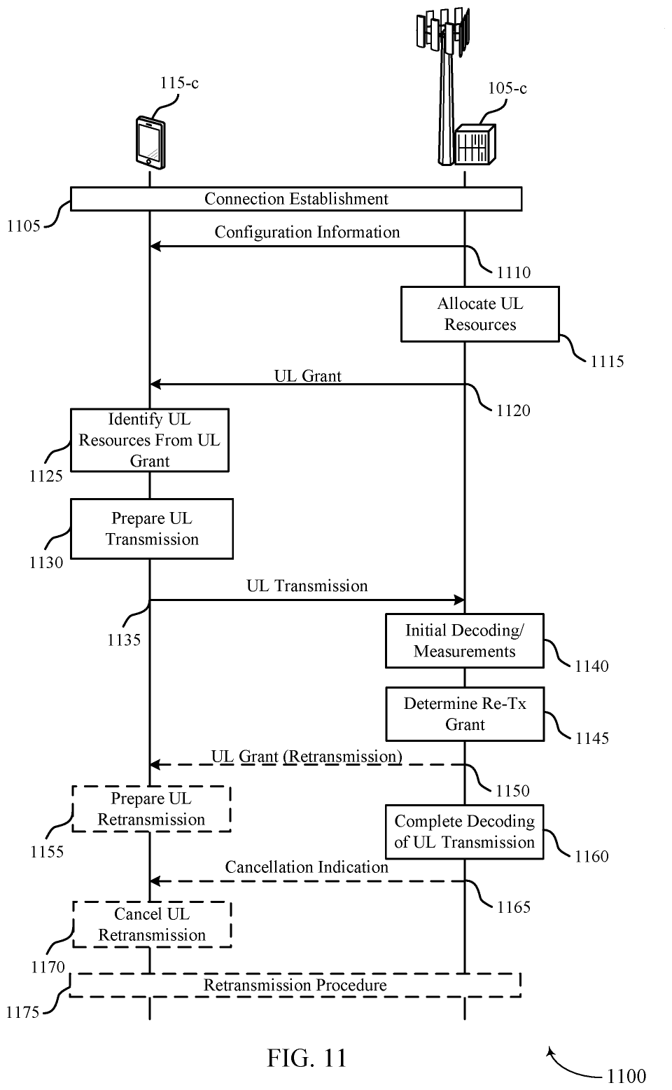

FIG. 11 illustrates an example of a process flow 1100 that supports acknowledgment feedback techniques in wireless communications in accordance with aspects of the present disclosure. In some examples, process flow 1100 may implement aspects of wireless communications system 100 or 200. The process flow 1100 may include base station 105-c and UE 115-c, which may be examples of the corresponding devices described with reference to FIGS. 1 through 9. Base station 105-c and UE 115-c may implement one or more techniques for fast uplink retransmissions as discussed herein. Alternative examples of the following may be implemented, where some steps are performed in a different order than described or are not performed at all. In some cases, steps may include additional features not mentioned below, or further steps may be added.

At 1105, the UE 115-c and base station 105-c may perform a connection establishment that provides a communications link. The connection establishment may be performed according to established connection establishment techniques, such as through RRC signaling. In some cases, as part of the connection establishment, the UE may provide an indication of a capability to perform fast uplink retransmissions and cancellation (e.g., via UE capability signaling). The base station 105-c, based on the indicated capability, may determine to configure the UE for fast retransmissions. In some cases, the base station 105-c may determine to configure fast uplink retransmissions based on one or more system conditions, system loading, channel conditions at the UE 115-c, or any combinations thereof.

At 1110, the base station 105-c may transmit configuration information to the UE 115-c. In some cases, the configuration information may indicate that the UE 115-c and base station 105-c may use fast uplink retransmissions in conjunction with a cancellation indication to provide retransmissions of uplink data communications according to a reduced timeline. In some cases, the configuration information may include resources that are to be monitored for a cancellation indication in the event that a fast retransmission grant is provided to the UE 115-c. In some cases, the configuration information may include a time and/or frequency offset of resources to be monitored for a cancellation indication relative to resources that include a retransmission grant.

At 1115, the base station 105-c may allocate uplink resources for uplink communications from the UE 115-c. In some cases, the uplink resources may include PUSCH resources for an uplink data transmission from the UE 115-c.

At 1120, the base station 105-c may transmit an uplink grant to the UE 115-c. In some cases, the uplink grant may include an indication of the uplink resources and may be transmitted in a PDCCH transmission to the UE 115-c.

At 1125, the UE 115-c may identify the uplink resources based on the uplink grant. In some cases, the UE 115-c may determine that the base station 105-c may provide a fast retransmission grant to the UE 115-c based on an initial feedback determination at the base station 105-c (e.g., based on a service type indicated in the uplink grant).

At 1130, the UE 115-c may prepare the uplink transmission. In some cases, the UE 115-c may prepare the uplink transmission according to an uplink processing timeline between receipt of the uplink grant and the start of the uplink resources. At 1135, the UE 115-c may transmit the uplink transmission to the base station 105-c.

At 1140, the base station 105-c determine an initial measurement or perform initial decoding of the uplink transmission. In some cases, the base station 105-c may perform an initial measurement based on a reference signal received power (RSRP) of a DMRS provided with the uplink transmission. In other cases, the initial measurement may be based on one or more of a RSRP, reference signal received quality (RSRQ), signal to noise ratio (SNR) of the DMRS, a signal to interference and noise ratio (SINR) of the DMRS, or any combinations thereof. In some cases, the base station 105-c may perform an initial number of decoding iterations on the received uplink transmissions and may make a determination based on the initial number of decoding iterations of whether successful decoding is likely or unlikely.

At 1145, the base station 105-c may determine whether to allocate uplink resources for a retransmission of the uplink transmission. In some cases, the determination to allocate retransmission resources may be a fast retransmission determination that is based at least in part on the initial measurement or decoding performed on the uplink transmission. In some cases, such a determination may be based on whether the initial measurement or decoding indicates whether successful or unsuccessful decoding of the uplink transmission is likely. In some cases, the base station 105-c may determine to transmit the retransmission grant only in cases where the initial determination indicates unsuccessful decoding of the downlink transmission. At 1150, in cases where the base station 105-c determines to provide the retransmission uplink grant, the base station 105-c may transmit the retransmission uplink grant to the UE 115-c.

At 1155, the UE 115-c, if the retransmission uplink grant is received, prepares the uplink retransmission in accordance with the retransmission uplink grant. The UE 115-c may also monitor for a cancellation indication from the base station 105-c, and in the event that a cancellation indication is not received may retransmit the uplink transmission in accordance with retransmission procedure, at 1175.

At 1160, the base station 105-c may complete decoding of the uplink transmission. In cases where the base station 105-c is able to successfully decode the uplink transmission after transmitting the retransmission uplink grant, the base station 105-c, at 1165, may transmit the cancellation indication to the UE 115-c. At 1170, the UE 115-c may receive the cancellation indication, if transmitted, and cancel the uplink retransmission.

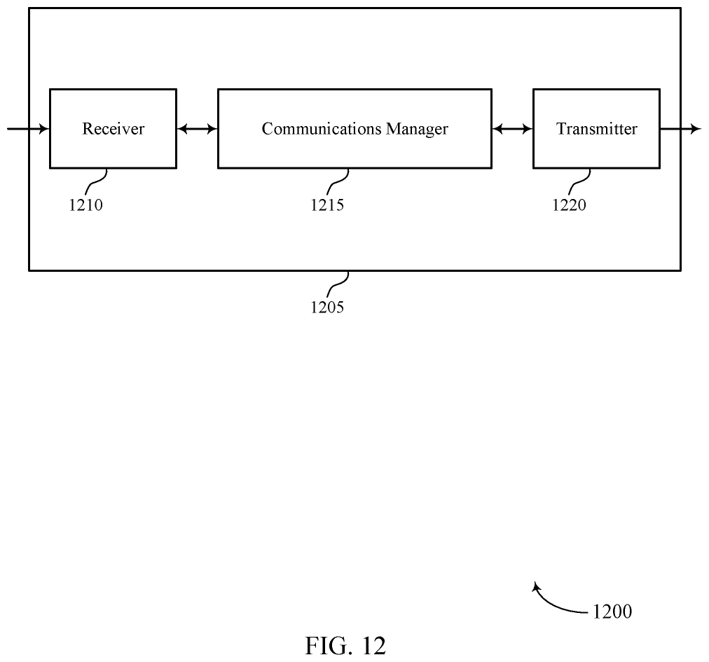

FIG. 12 shows a block diagram 1200 of a device 1205 that supports acknowledgment feedback techniques in wireless communications in accordance with aspects of the present disclosure. The device 1205 may be an example of aspects of a UE 115 as described herein. The device 1205 may include a receiver 1210, a communications manager 1215, and a transmitter 1220. The device 1205 may also include a processor. Each of these components may be in communication with one another (e.g., via one or more buses).

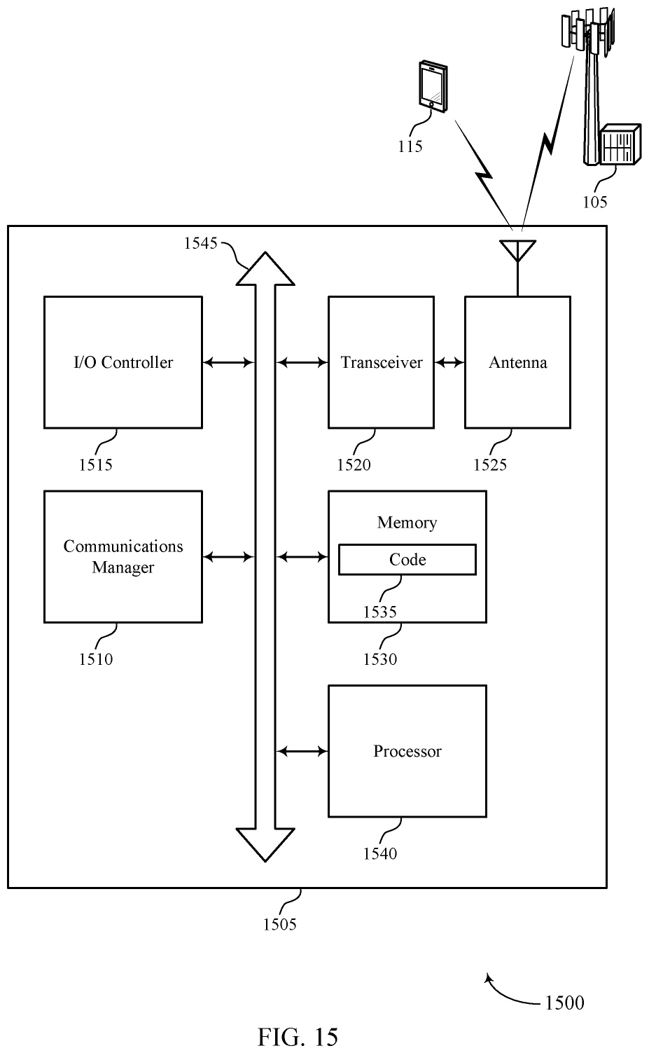

The receiver 1210 may receive information such as packets, user data, or control information associated with various information channels (e.g., control channels, data channels, and information related to acknowledgment feedback techniques in wireless communications, etc.). Information may be passed on to other components of the device 1205. The receiver 1210 may be an example of aspects of the transceiver 1520 described with reference to FIG. 15. The receiver 1210 may utilize a single antenna or a set of antennas.

The communications manager 1215 may receive, from a base station, a first downlink grant that identifies a first set of downlink resources for a downlink transmission to the UE, identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempt to decode the downlink transmission from the base station in the first set of downlink resources, and transmit one or more of the first feedback transmission or the second feedback transmission based on whether the downlink transmission is successfully decoded.

The communications manager 1215 may also transmit a first uplink communication to a base station, prepare a retransmission of the first uplink communication responsive to receiving the retransmission grant, discontinue preparation of the retransmission responsive to receiving the cancellation indication, receive a retransmission grant from the base station that indicates that the first uplink communication is to be retransmitted to the base station, and monitor for a cancellation indication from the base station that indicates the retransmission grant is canceled. The communications manager 1215 may be an example of aspects of the communications manager 1510 described herein.

The communications manager 1215, or its sub-components, may be implemented in hardware, code (e.g., software or firmware) executed by a processor, or any combination thereof. If implemented in code executed by a processor, the functions of the communications manager 1215, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1220 may transmit signals generated by other components of the device 1205. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

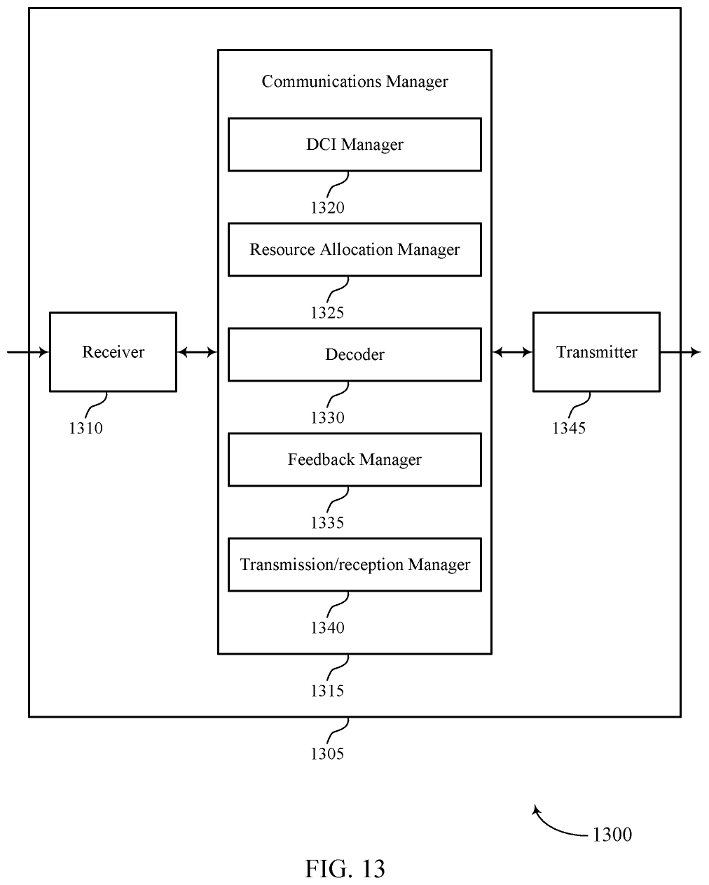

FIG. 13 shows a block diagram 1300 of a device 1305 that supports acknowledgment feedback techniques in wireless communications in accordance with aspects of the present disclosure. The device 1305 may be an example of aspects of a device 1205, or a UE 115 as described herein. The device 1305 may include a receiver 1310, a communications manager 1315, and a transmitter 1345. The device 1305 may also include a processor. Each of these components may be in communication with one another (e.g., via one or more buses).

The receiver 1310 may receive information such as packets, user data, or control information associated with various information channels (e.g., control channels, data channels, and information related to acknowledgment feedback techniques in wireless communications, etc.). Information may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a DCI manager 1320, a resource allocation manager 1325, a decoder 1330, a feedback manager 1335, and a transmission/reception manager 1340. The communications manager 1315 may be an example of aspects of the communications manager 1510 described herein.

The actions performed by the communications manager 1315 as described herein may be implemented to realize one or more potential advantages. One implementation may provide improved quality and reliability of service at the UE 115, as latency and the number of separate resources allocated to the UE 115 may be reduced.

The DCI manager 1320 may receive, from a base station, a first downlink grant that identifies a first set of downlink resources for a downlink transmission to the UE.

The resource allocation manager 1325 may identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE.

The decoder 1330 may attempt to decode the downlink transmission from the base station in the first set of downlink resources.

The feedback manager 1335 may transmit one or more of the first feedback transmission or the second feedback transmission based on whether the downlink transmission is successfully decoded. The feedback manager 1335 may also receive, via a radio resource control configuration or a downlink grant, an indication of a feedback mode of the UE, wherein transmitting one or more of the first feedback transmission or the second feedback transmission is further based at least in part on the feedback mode of the UE.

In some cases, the resource allocation manager 1325 may receive a retransmission grant from the base station that indicates that the first uplink communication is to be retransmitted to the base station.

In some cases, the feedback manager 1335 may monitor for a cancellation indication from the base station that indicates the retransmission grant is canceled.

The transmission/reception manager 1340 may transmit a first uplink communication to a base station, prepare a retransmission of the first uplink communication responsive to receiving the retransmission grant, and discontinue preparation of the retransmission responsive to receiving the cancellation indication.

The transmitter 1345 may transmit signals generated by other components of the device 1305. In some examples, the transmitter 1345 may be collocated with a receiver 1310 in a transceiver module. For example, the transmitter 1345 may be an example of aspects of the transceiver 1520 described with reference to FIG. 15. The transmitter 1345 may utilize a single antenna or a set of antennas.

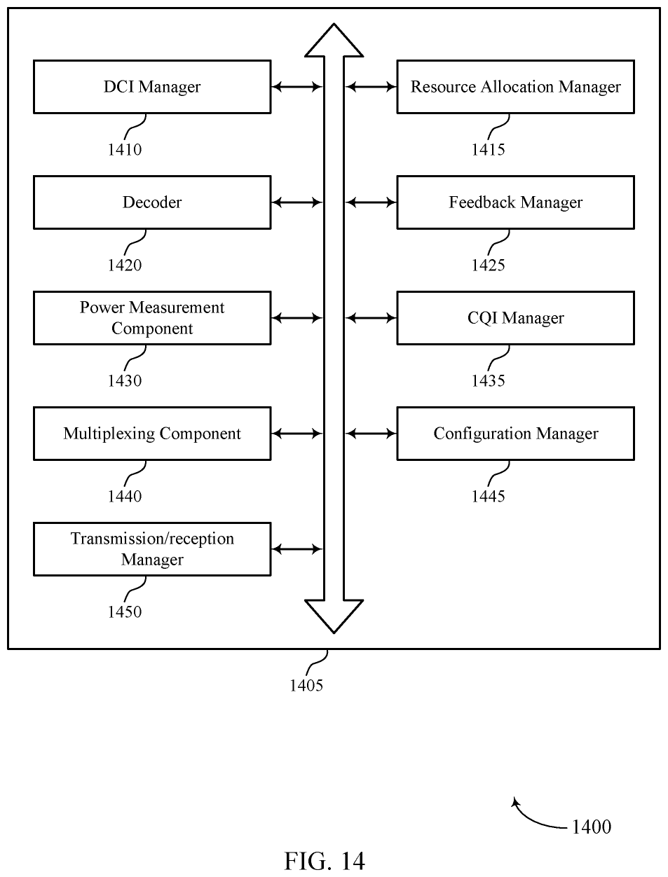

FIG. 14 shows a block diagram 1400 of a communications manager 1405 that supports acknowledgment feedback techniques in wireless communications in accordance with aspects of the present disclosure. The communications manager 1405 may be an example of aspects of a communications manager 1215, a communications manager 1315, or a communications manager 1510 described herein. The communications manager 1405 may include a DCI manager 1410, a resource allocation manager 1415, a decoder 1420, a feedback manager 1425, a power measurement component 1430, a CQI manager 1435, a multiplexing component 1440, a configuration manager 1445, and a transmission/reception manager 1450. Each of these modules may communicate, directly or indirectly, with one another (e.g., via one or more buses).

The DCI manager 1410 may receive, from a base station, a first downlink grant that identifies a first set of downlink resources for a downlink transmission to the UE. In some examples, the DCI manager 1410 may receive, responsive to a negative acknowledgment feedback via the first set of uplink resources, a second downlink grant that identifies a second set of downlink resources for a retransmission of the downlink transmission to the UE, where the second downlink grant is received prior to a starting time of the second set of uplink resources.

The resource allocation manager 1415 may identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE.

In some examples, the resource allocation manager 1415 may receive a resource indicator with the first downlink grant. In some examples, the resource allocation manager 1415 may determine the first set of uplink resources and the second set of uplink resources for feedback transmissions based on a mapping of uplink resource pairs to an index value of the resource indicator. In some examples, the resource allocation manager 1415 may receive a first resource indicator with the first downlink grant that indicates the first set of uplink resources, and a second resource indicator with the first downlink grant that indicates the second set of uplink resources. In some examples, the resource allocation manager 1415 may determine the second set of uplink resources based on a mapping between the first set of uplink resources and the second set of uplink resources. In some cases, the mapping indicates a relative timing difference between a first starting time of the first set of uplink resources and a second starting time of the second set of uplink resources. In some examples, the resource allocation manager 1415 may receive the retransmission grant in downlink resources that at least partially overlap in time with uplink resources used for transmitting the first uplink communication.

In some cases, the second downlink grant indicates a single set of uplink resources for acknowledgment of the retransmission of the downlink transmission, and the UE transmits a single feedback transmission to acknowledge receipt of the retransmission of the downlink transmission based on the single set of uplink resources.

In some examples, the resource allocation manager 1415 may receive a retransmission grant from the base station that indicates that the first uplink communication is to be retransmitted to the base station.

The decoder 1420 may attempt to decode the downlink transmission from the base station in the first set of downlink resources. In some examples, the decoder 1420 may perform an initial decoding of the downlink transmission, and where the first feedback transmission is based on the initial decoding of the downlink transmission. In some examples, the decoder 1420 may perform a first number of decoding iterations on the downlink transmission, where the first number of decoding iterations is less than a second number of decoding iterations to determine a final decoding result of the downlink transmission.

In some examples, the decoder 1420 may determine, after the initial decoding, a final decoding result of the downlink transmission, and where the second feedback transmission is based on the final decoding result of the downlink transmission.

The feedback manager 1425 may transmit one or more of the first feedback transmission or the second feedback transmission based on whether the downlink transmission is successfully decoded. In some examples, the feedback manager 1425 may transmit the first feedback transmission based on an initial decoding of the downlink transmission indicating that the downlink transmission is unsuccessfully received. In some examples, the feedback manager 1425 may skip the transmitting of the first feedback transmission based on the initial decoding of the downlink transmission indicating that the downlink transmission is successfully received. In some examples, the feedback manager 1425 may transmit the first feedback transmission based on an initial decoding of the downlink transmission, the first feedback transmission indicating that the downlink transmission is successfully or unsuccessfully received at the UE. The feedback manager 1425 may receive, via a radio resource control configuration or a downlink grant, an indication of a feedback mode of the UE, wherein transmitting one or more of the first feedback transmission or the second feedback transmission is further based at least in part on the feedback mode of the UE.

In some examples, the feedback manager 1425 may transmit the second feedback transmission based on a final decoding result of the downlink transmission. In some examples, the feedback manager 1425 may transmit the second feedback transmission based on a final decoding of the downlink transmission when the first feedback transmission indicates unsuccessful decoding of the downlink transmission. In some examples, the feedback manager 1425 may skip the transmission of the second feedback transmission when the first feedback transmission indicates successful decoding of the downlink transmission.

In some cases, the initial decoding has a first processing time that is shorter than a second processing time associated with the final decoding, and where the starting time of the first set of uplink resources is later than a reference time plus the first processing time. In some cases, the reference time corresponds to an end time of the downlink transmission or to an end time of a demodulation reference signal transmitted in the downlink transmission. In some cases, a gap in time between an end time of the downlink transmission and a starting time of the first set of uplink resources is smaller than the second processing time for the UE to determine the final decoding result of the downlink transmission. In some cases, the retransmission grant indicates that an initial reception of the uplink communication at the base station fails to meet a predetermined criteria.

In some examples, the feedback manager 1425 may monitor for a cancellation indication from the base station that indicates the uplink retransmission grant is canceled. In some examples, the feedback manager 1425 may receive the cancellation indication in a predetermined bit sequence or downlink control information from the base station. In some examples, the feedback manager 1425 may determine that a cancellation indication time period has expired prior to receipt of the cancellation indication. In some cases, the cancellation indication time period corresponds to a preemption indication time period for the base station to preempt one or more uplink transmissions of one or more other UEs.

The transmission/reception manager 1450 may transmit a first uplink communication to a base station. In some examples, the transmission/reception manager 1450 may prepare a retransmission of the first uplink communication responsive to receiving the retransmission grant. In some examples, the transmission/reception manager 1450 may discontinue preparation of the retransmission responsive to receiving the cancellation indication. In some examples, the transmission/reception manager 1450 may transmit the retransmission of the first uplink communication responsive to the expiration of the cancellation indication time period.

The power measurement component 1430 may determine that a received power of the downlink transmission exceeds a threshold value. In some cases, the received power is measured based on either a reference signal transmitted with the downlink transmission (a downlink control channel) or a reference signal transmitted with a downlink data channel.

The CQI manager 1435 may transmit a channel quality indication with the first feedback transmission. In some cases, the channel quality indication provides a difference between a reference signal measurement of a reference signal provided with the downlink transmission and a prior reference signal measurement reported to the base station. In some cases, the first feedback transmission indicates successful or unsuccessful reception of the downlink transmission based on a value of the difference indicated in the channel quality indication. In some cases, a modulation and coding scheme (MCS) for a retransmission of the downlink transmission is based on an initial MCS of the downlink transmission and the difference indicated in the channel quality indication.

In some cases, the first feedback transmission includes one or more bits to indicate the NACK feedback for the one or more concurrent downlink transmissions, and the multiplexing component 1440 may multiplex feedback information for the two or more concurrent downlink transmissions in one or more of the first feedback transmission or the second feedback transmission. In some examples, the multiplexing component 1440 may transmit the first feedback transmission based at least in part on an initial decoding of one or more of the concurrent downlink transmissions indicating a negative acknowledgment (NACK) feedback of the associated downlink transmission at the UE. In some examples, the multiplexing component 1440 may determine that two or more of the concurrent downlink transmissions have NACK feedback. In some examples, the multiplexing component 1440 may select one of the two or more concurrent downlink transmissions that have the NACK feedback to report in the first feedback transmission based on a priority associated with each of the two or more concurrent downlink transmissions.

In some examples, the multiplexing component 1440 may multiplex first feedback information for less than all of the two or more concurrent downlink transmissions in the first feedback transmission based on an initial decoding of the two or more concurrent downlink transmissions. In some examples, the multiplexing component 1440 may multiplex second feedback information for each of the two or more concurrent downlink transmissions in the second feedback transmission based on a final decoding of the two or more concurrent downlink transmissions.

In some examples, the multiplexing component 1440 may multiplex first feedback information for each of the two or more concurrent downlink transmissions in the first feedback transmission based on an initial decoding of the two or more concurrent downlink transmissions. In some examples, the multiplexing component 1440 may multiplex second feedback information in the second feedback transmission only for concurrent downlink transmissions that had a negative acknowledgment (NACK) feedback in the first feedback transmission, where the second feedback information is based on a final decoding of associated downlink transmissions that had the NACK feedback.

The configuration manager 1445 may transmit a capability indication to the base station that indicates a UE capability to transmit uplink feedback using one or more of the first set of uplink resources or the second set of uplink resources. In some examples, the configuration manager 1445 may transmit a capability indication to the base station that indicates a UE capability to cancel the retransmission during a processing time for preparing the retransmission of the first uplink communication.

FIG. 15 shows a diagram of a system 1500 including a device 1505 that supports acknowledgment feedback techniques in wireless communications in accordance with aspects of the present disclosure. The device 1505 may be an example of or include the components of device 1205, device 1305, or a UE 115 as described herein. The device 1505 may include components for bi-directional voice and data communications including components for transmitting and receiving communications, including a communications manager 1510, an I/O controller 1515, a transceiver 1520, an antenna 1525, memory 1530, and a processor 1540. These components may be in electronic communication via one or more buses (e.g., bus 1545).

The communications manager 1510 may receive, from a base station, a first downlink grant that identifies a first set of downlink resources for a downlink transmission to the UE, identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE, attempt to decode the downlink transmission from the base station in the first set of downlink resources, and transmit one or more of the first feedback transmission or the second feedback transmission based on whether the downlink transmission is successfully decoded.

The communications manager 1510 may also transmit a first uplink communication to a base station, prepare a retransmission of the first uplink communication responsive to receiving the retransmission grant, discontinue preparation of the retransmission responsive to receiving the cancellation indication, receive a retransmission grant from the base station that indicates that the first uplink communication is to be retransmitted to the base station, and monitor for a cancellation indication from the base station that indicates the retransmission grant is canceled.

The I/O controller 1515 may manage input and output signals for the device 1505. The I/O controller 1515 may also manage peripherals not integrated into the device 1505. In some cases, the I/O controller 1515 may represent a physical connection or port to an external peripheral. In some cases, the I/O controller 1515 may utilize an operating system such as iOS®, ANDROID®, MS-DOS®, MS-WINDOWS®, OS/2®, UNIX®, LINUX®, or another known operating system. In other cases, the I/O controller 1515 may represent or interact with a modem, a keyboard, a mouse, a touchscreen, or a similar device. In some cases, the I/O controller 1515 may be implemented as part of a processor. In some cases, a user may interact with the device 1505 via the I/O controller 1515 or via hardware components controlled by the I/O controller 1515.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include RAM and ROM. The memory 1530 may store computer-readable, computer-executable code 1535 including instructions that, when executed, cause the processor to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting acknowledgment feedback techniques in wireless communications).

Based on retransmissions based on initial decoding or measurements occurring within latency target timelines for low latency services, a processor 1540 of a UE 115 may enhance system reliability and latency. As such, the processor 1540 may be may be ready to respond more efficiently through the reduction of a ramp up in processing power as a result of missing latency target timelines.

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

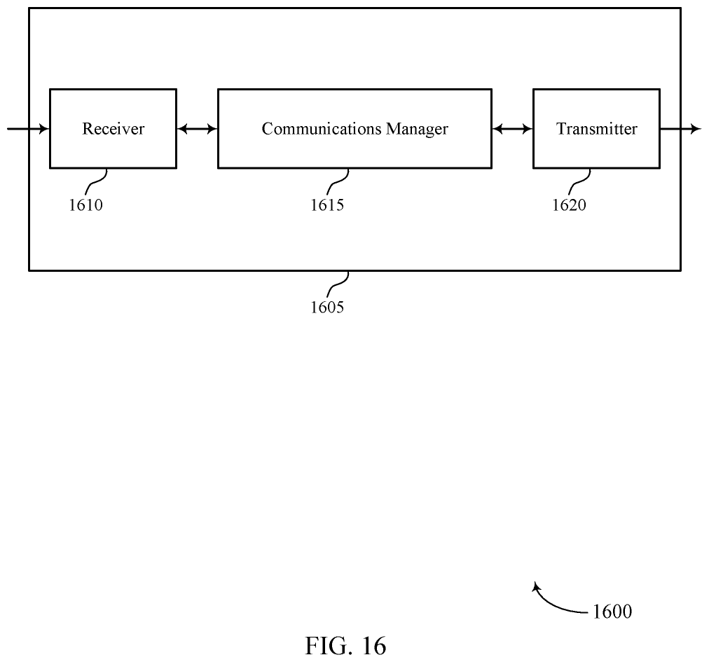

FIG. 16 shows a block diagram 1600 of a device 1605 that supports acknowledgment feedback techniques in wireless communications in accordance with aspects of the present disclosure. The device 1605 may be an example of aspects of a base station 105 as described herein. The device 1605 may include a receiver 1610, a communications manager 1615, and a transmitter 1620. The device 1605 may also include a processor. Each of these components may be in communication with one another (e.g., via one or more buses).

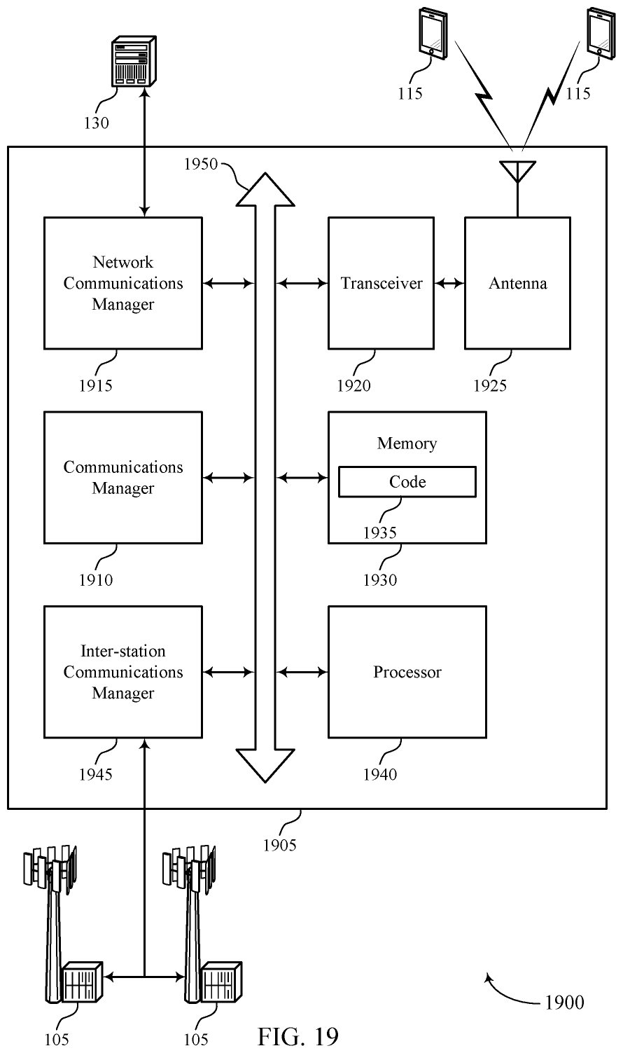

The receiver 1610 may receive information such as packets, user data, or control information associated with various information channels (e.g., control channels, data channels, and information related to acknowledgment feedback techniques in wireless communications, etc.). Information may be passed on to other components of the device 1605. The receiver 1610 may be an example of aspects of the transceiver 1920 described with reference to FIG. 19. The receiver 1610 may utilize a single antenna or a set of antennas.

The communications manager 1615 may identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmit a first downlink grant and the first downlink transmission to the UE, where the first downlink grant identifies the first set of downlink resources and one or more of the first set of uplink resources or the second set of uplink resources, monitor for the first feedback transmission in the first set of uplink resources, and transmit a second downlink grant that schedules a retransmission of the first downlink transmission to the UE based on the first feedback transmission indicating unsuccessful receipt of the first downlink transmission at the UE.

The communications manager 1615 may also transmit a first uplink grant that includes first uplink resources for a first uplink communication from a UE, transmit a retransmission uplink grant to the UE to retransmit the first uplink communication based on an initial evaluation of the first uplink communication failing to meet a predetermined criteria, receive the first uplink communication in the first uplink resources, determine that a final decoding output results in a successful decoding of the first uplink communication, and transmit a cancellation indication to the UE that indicates the retransmission uplink grant is canceled. The communications manager 1615 may be an example of aspects of the communications manager 1910 described herein.

The communications manager 1615, or its sub-components, may be implemented in hardware, code (e.g., software or firmware) executed by a processor, or any combination thereof. If implemented in code executed by a processor, the functions of the communications manager 1615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1615, or its sub-components, may be physically located at various positions, including being distributed such that portions of functions are implemented at different physical locations by one or more physical components. In some examples, the communications manager 1615, or its sub-components, may be a separate and distinct component in accordance with various aspects of the present disclosure. In some examples, the communications manager 1615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1620 may transmit signals generated by other components of the device 1605. In some examples, the transmitter 1620 may be collocated with a receiver 1610 in a transceiver module. For example, the transmitter 1620 may be an example of aspects of the transceiver 1920 described with reference to FIG. 19. The transmitter 1620 may utilize a single antenna or a set of antennas.

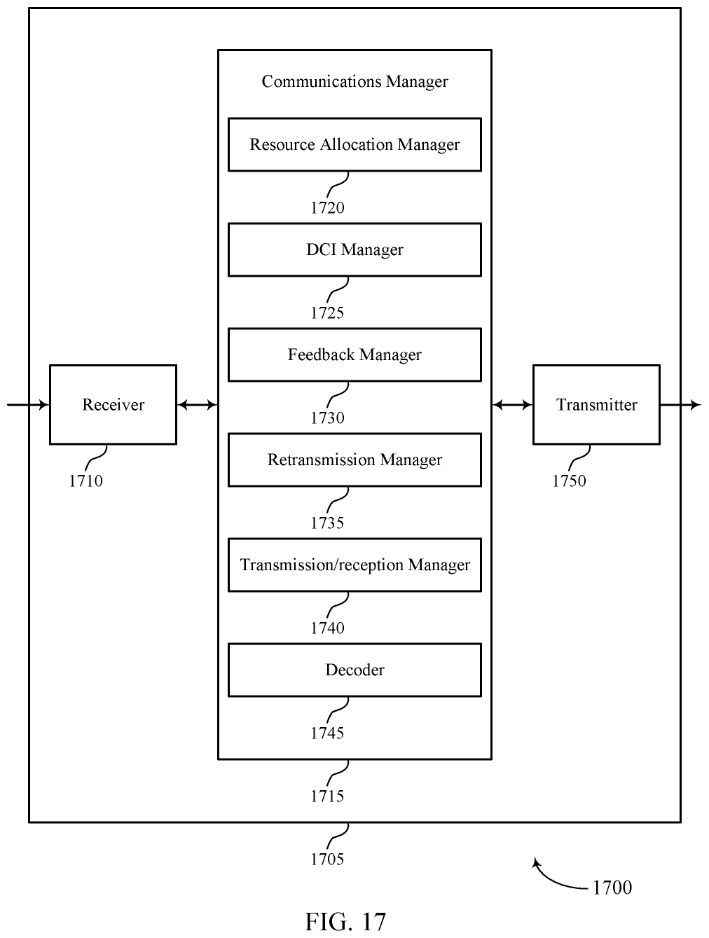

FIG. 17 shows a block diagram 1700 of a device 1705 that supports acknowledgment feedback techniques in wireless communications in accordance with aspects of the present disclosure. The device 1705 may be an example of aspects of a device 1605, or a base station 105 as described herein. The device 1705 may include a receiver 1710, a communications manager 1715, and a transmitter 1750. The device 1705 may also include a processor. Each of these components may be in communication with one another (e.g., via one or more buses).

The receiver 1710 may receive information such as packets, user data, or control information associated with various information channels (e.g., control channels, data channels, and information related to acknowledgment feedback techniques in wireless communications, etc.). Information may be passed on to other components of the device 1705. The receiver 1710 may be an example of aspects of the transceiver 1920 described with reference to FIG. 19. The receiver 1710 may utilize a single antenna or a set of antennas.

The communications manager 1715 may be an example of aspects of the communications manager 1615 as described herein. The communications manager 1715 may include a resource allocation manager 1720, a DCI manager 1725, a feedback manager 1730, a retransmission manager 1735, a transmission/reception manager 1740, and a decoder 1745. The communications manager 1715 may be an example of aspects of the communications manager 1910 described herein.

The actions performed by the communications manager 1715 as described herein may be implemented to realize one or more potential advantages. One implementation may provide improved quality and reliability of service at the base station 105, as latency and the number of separate resources allocated to the base station 105 may be reduced.

The resource allocation manager 1720 may identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission.

The DCI manager 1725 may transmit a first downlink grant and the first downlink transmission to the UE, where the first downlink grant identifies the first set of downlink resources and one or more of the first set of uplink resources or the second set of uplink resources.

The feedback manager 1730 may monitor for the first feedback transmission in the first set of uplink resources.

The retransmission manager 1735 may transmit a second downlink grant that schedules a retransmission of the first downlink transmission to the UE based on the first feedback transmission indicating unsuccessful receipt of the first downlink transmission at the UE.

In some cases, the DCI manager 1725 may transmit a first uplink grant that includes first uplink resources for a first uplink communication from a UE and transmit a retransmission uplink grant to the UE to retransmit the first uplink communication based on an initial evaluation of the first uplink communication failing to meet a predetermined criteria.

The transmission/reception manager 1740 may receive the first uplink communication in the first uplink resources.

The decoder 1745 may determine that a final decoding output results in a successful decoding of the first uplink communication.

The retransmission manager 1735 may transmit a cancellation indication to the UE that indicates the retransmission uplink grant is canceled.

The transmitter 1750 may transmit signals generated by other components of the device 1705. In some examples, the transmitter 1750 may be collocated with a receiver 1710 in a transceiver module. For example, the transmitter 1750 may be an example of aspects of the transceiver 1920 described with reference to FIG. 19. The transmitter 1750 may utilize a single antenna or a set of antennas.

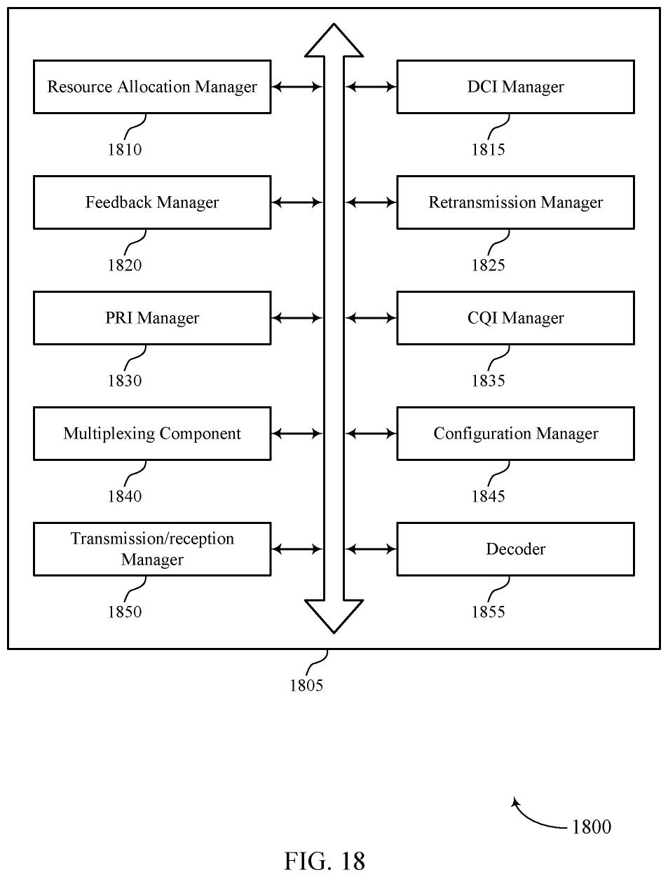

FIG. 18 shows a block diagram 1800 of a communications manager 1805 that supports acknowledgment feedback techniques in wireless communications in accordance with aspects of the present disclosure. The communications manager 1805 may be an example of aspects of a communications manager 1615, a communications manager 1715, or a communications manager 1910 described herein. The communications manager 1805 may include a resource allocation manager 1810, a DCI manager 1815, a feedback manager 1820, a retransmission manager 1825, a PRI manager 1830, a CQI manager 1835, a multiplexing component 1840, a configuration manager 1845, a transmission/reception manager 1850, and a decoder 1855. Each of these modules may communicate, directly or indirectly, with one another (e.g., via one or more buses).

The resource allocation manager 1810 may identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission. In some cases, the first set of uplink resources at least partially overlaps in time with the first set of downlink resources.

The DCI manager 1815 may transmit a first downlink grant and the first downlink transmission to the UE, where the first downlink grant identifies the first set of downlink resources and one or more of the first set of uplink resources or the second set of uplink resources. In some examples, the DCI manager 1815 may determine a modulation and coding scheme (MCS) for the retransmission of the first downlink transmission based on the difference indicated in the channel quality indication. In some cases, the second downlink grant is transmitted prior to a second starting time of the second set of uplink resources.

In some examples, the DCI manager 1815 may transmit a first uplink grant that includes first uplink resources for a first uplink communication from a UE. In some examples, the DCI manager 1815 may transmit a retransmission uplink grant to the UE to retransmit the first uplink communication based on an initial evaluation of the first uplink communication failing to meet a predetermined criteria. In some cases, the retransmission grant is transmitted in downlink resources that at least partially overlap in time with the first uplink resources.

In some cases, the DCI manager 1815 may transmit a cancellation indication. In some cases, the cancellation indication is transmitted using a predetermined bit sequence or downlink control information transmitted to the UE. In some cases, the cancellation indication is provided in downlink time resources that correspond to time resources for a preemption indication that preempts one or more uplink transmissions of one or more other UEs, and where the preemption indication is transmitted to the one or more other UEs when the final decoding output results in an unsuccessful decoding of the first uplink communication.

The feedback manager 1820 may monitor for the first feedback transmission in the first set of uplink resources. In some examples, the feedback manager 1820 may determine that the UE implicitly acknowledges the first downlink transmission based on the first feedback transmission being absent from the first set of uplink resources. In some examples, the feedback manager 1820 may monitor for the second feedback transmission in the second set of uplink resources for an explicit acknowledgment of the first downlink transmission.

In some examples, the feedback manager 1820 may receive the first feedback transmission indicating that the first downlink transmission is successfully or unsuccessfully received at the UE. In some examples, the feedback manager 1820 may monitor for the second feedback transmission only when the first feedback transmission indicates unsuccessful decoding of the first downlink transmission at the UE. In some cases, the first feedback transmission indicates an acknowledgment (ACK) or negative acknowledgment (NACK) of the first downlink transmission based on an initial decoding of the first downlink transmission at the UE. In some cases, the second feedback transmission indicates ACK/NACK of the first downlink transmission based on the final decoding result of the first downlink transmission at the UE. In some cases, the initial decoding is based on a received power of the first downlink transmission at the UE relative to a threshold value. In some cases, the received power is measured based on a reference signal transmitted with the first downlink transmission. In some cases, the initial decoding is based on a first number of decoding iterations performed at the UE on the first downlink transmission, where the first number of decoding iterations is less than a second number of decoding iterations to determine the final decoding result of the first downlink transmission.

The retransmission manager 1825 may transmit a second downlink grant that schedules a retransmission of the first downlink transmission to the UE based on the first feedback transmission indicating unsuccessful receipt of the first downlink transmission at the UE.

In some examples, the retransmission manager 1825 may transmit a cancellation indication to the UE that indicates the retransmission uplink grant is canceled.

The transmission/reception manager 1850 may receive the first uplink communication in the first uplink resources. The decoder 1855 may determine that a final decoding output results in a successful decoding of the first uplink communication. In some examples, the decoder 1855 may perform the initial evaluation based on a first number of decoding iterations on the first uplink communication, where the first number of decoding iterations is less than a second number of decoding iterations to determine the final decoding output. In some examples, the decoder 1855 may perform the initial evaluation based on a received power of the first uplink communication relative to a threshold value.

The PRI manager 1830 may transmit a resource indicator with the first downlink grant that indicates the first set of uplink resources and the second set of uplink resources based on a mapping of uplink resource pairs to an index value of the resource indicator. In some examples, the PRI manager 1830 may transmit a first resource indicator and a second resource indicator with the first downlink grant, where the first resource indicator is mapped to the first set of uplink resources, and the second resource indicator is mapped to the second set of uplink resources. In some examples, the PRI manager 1830 may transmit a resource indicator with the first downlink grant that indicates the first set of uplink resources. In some examples, the PRI manager 1830 may determine the second set of uplink resources based on a mapping between the first set of uplink resources and the second set of uplink resources.

The CQI manager 1835 may determine whether the first feedback transmission indicates successful or unsuccessful reception of the first downlink transmission based on a value of the difference indicated in the channel quality indication. In some cases, the first feedback transmission includes a channel quality indication. In some cases, the channel quality indication provides a difference between a reference signal measurement at the UE of a reference signal provided with the first downlink transmission and a prior reference signal measurement reported by the UE.

The multiplexing component 1840 may monitor for multiplexed feedback information for the two or more concurrent downlink transmissions in one or more of the first feedback transmission or the second feedback transmission. In some examples, the multiplexing component 1840 may when two or more of the concurrent downlink transmissions have NACK feedback, the first feedback transmission indicates NACK feedback based on a priority associated with each of the two or more concurrent downlink transmissions. In some cases, the first feedback transmission indicates negative acknowledgment (NACK) feedback of one or more of the concurrent downlink transmissions at the UE. In some cases, the first feedback transmission includes feedback information for less than all of the two or more concurrent downlink transmissions, and the second feedback transmission includes feedback information for each of the two or more concurrent downlink transmissions based on a final decoding of the two or more concurrent downlink transmissions at the UE. In some cases, the first feedback transmission includes feedback information for each of the two or more concurrent downlink transmissions, and the second feedback transmission includes feedback information only for concurrent downlink transmissions that had a negative acknowledgment (NACK) feedback in the first feedback transmission.

The configuration manager 1845 may receive a capability indication from the UE that indicates a capability to transmit uplink feedback using one or more of the first set of uplink resources or the second set of uplink resources. In some examples, the configuration manager 1845 may receive a capability indication from the UE that indicates a capability to cancel the retransmission uplink grant during a processing time for preparing a retransmission of the first uplink communication.

FIG. 19 shows a diagram of a system 1900 including a device 1905 that supports acknowledgment feedback techniques in wireless communications in accordance with aspects of the present disclosure. The device 1905 may be an example of or include the components of device 1605, device 1705, or a base station 105 as described herein. The device 1905 may include components for bi-directional voice and data communications including components for transmitting and receiving communications, including a communications manager 1910, a network communications manager 1915, a transceiver 1920, an antenna 1925, memory 1930, a processor 1940, and an inter-station communications manager 1945. These components may be in electronic communication via one or more buses (e.g., bus 1950).

The communications manager 1910 may identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission, transmit a first downlink grant and the first downlink transmission to the UE, where the first downlink grant identifies the first set of downlink resources and one or more of the first set of uplink resources or the second set of uplink resources, monitor for the first feedback transmission in the first set of uplink resources, and transmit a second downlink grant that schedules a retransmission of the first downlink transmission to the UE based on the first feedback transmission indicating unsuccessful receipt of the first downlink transmission at the UE.

The communications manager 1910 may also transmit a first uplink grant that includes first uplink resources for a first uplink communication from a UE, transmit a retransmission uplink grant to the UE to retransmit the first uplink communication based on an initial evaluation of the first uplink communication failing to meet a predetermined criteria, receive the first uplink communication in the first uplink resources, determine that a final decoding output results in a successful decoding of the first uplink communication, and transmit a cancellation indication to the UE that indicates the retransmission uplink grant is canceled.

The network communications manager 1915 may manage communications with the core network (e.g., via one or more wired backhaul links). For example, the network communications manager 1915 may manage the transfer of data communications for client devices, such as one or more UEs 115.

The transceiver 1920 may communicate bi-directionally, via one or more antennas, wired, or wireless links as described above. For example, the transceiver 1920 may represent a wireless transceiver and may communicate bi-directionally with another wireless transceiver. The transceiver 1920 may also include a modem to modulate the packets and provide the modulated packets to the antennas for transmission, and to demodulate packets received from the antennas.

In some cases, the wireless device may include a single antenna 1925. However, in some cases the device may have more than one antenna 1925, which may be capable of concurrently transmitting or receiving multiple wireless transmissions.

The memory 1930 may include RAM, ROM, or a combination thereof. The memory 1930 may store computer-readable code 1935 including instructions that, when executed by a processor (e.g., the processor 1940) cause the device to perform various functions described herein. In some cases, the memory 1930 may contain, among other things, a BIOS which may control basic hardware or software operation such as the interaction with peripheral components or devices.

The processor 1940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some cases, a memory controller may be integrated into processor 1940. The processor 1940 may be configured to execute computer-readable instructions stored in a memory (e.g., the memory 1930) to cause the device 1905 to perform various functions (e.g., functions or tasks supporting acknowledgment feedback techniques in wireless communications).

Based on retransmissions based on initial decoding or measurements occurring within latency target timelines for low latency services, a processor 1940 of a base station 105 may enhance system reliability and latency. Allowing the base station 105 to be more aggressive in scheduling or selecting transmission parameters (e.g., selecting a MCS for transmissions that allows for scheduling of more UEs) may help to enhance overall system efficiency. As such, the processor 1940 may be may be ready to respond more efficiently through the reduction of a ramp up in processing power as a result of missing latency target timelines.

The inter-station communications manager 1945 may manage communications with other base station 105, and may include a controller or scheduler for controlling communications with UEs 115 in cooperation with other base stations 105. For example, the inter-station communications manager 1945 may coordinate scheduling for transmissions to UEs 115 for various interference mitigation techniques such as beamforming or joint transmission. In some examples, the inter-station communications manager 1945 may provide an X2 interface within an LTE/LTE-A wireless communication network technology to provide communication between base stations 105.

The code 1935 may include instructions to implement aspects of the present disclosure, including instructions to support wireless communications. The code 1935 may be stored in a non-transitory computer-readable medium such as system memory or other type of memory. In some cases, the code 1935 may not be directly executable by the processor 1940 but may cause a computer (e.g., when compiled and executed) to perform functions described herein.

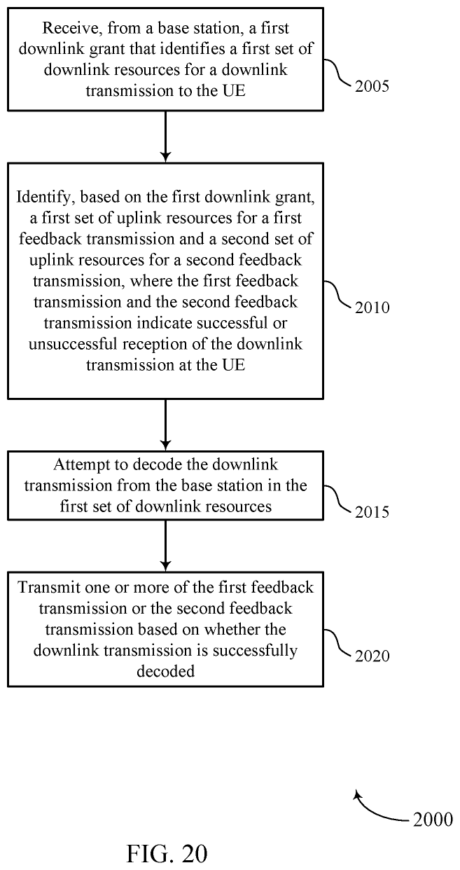

FIG. 20 shows a flowchart illustrating a method 2000 that supports acknowledgment feedback techniques in wireless communications in accordance with aspects of the present disclosure. The operations of method 2000 may be implemented by a UE 115 or its components as described herein. For example, the operations of method 2000 may be performed by a communications manager as described with reference to FIGS. 12 through 15. In some examples, a UE may execute a set of instructions to control the functional elements of the UE to perform the functions described below. Additionally or alternatively, a UE may perform aspects of the functions described below using special-purpose hardware.

At 2005, the UE may receive, from a base station, a first downlink grant that identifies a first set of downlink resources for a downlink transmission to the UE. The operations of 2005 may be performed according to the methods described herein. In some examples, aspects of the operations of 2005 may be performed by a DCI manager as described with reference to FIGS. 12 through 15.

At 2010, the UE may identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE. The operations of 2010 may be performed according to the methods described herein. In some examples, aspects of the operations of 2010 may be performed by a resource allocation manager as described with reference to FIGS. 12 through 15.

At 2015, the UE may attempt to decode the downlink transmission from the base station in the first set of downlink resources. The operations of 2015 may be performed according to the methods described herein. In some examples, aspects of the operations of 2015 may be performed by a decoder as described with reference to FIGS. 12 through 15.

At 2020, the UE may transmit one or more of the first feedback transmission or the second feedback transmission based on whether the downlink transmission is successfully decoded. The operations of 2020 may be performed according to the methods described herein. In some examples, aspects of the operations of 2020 may be performed by a feedback manager as described with reference to FIGS. 12 through 15.

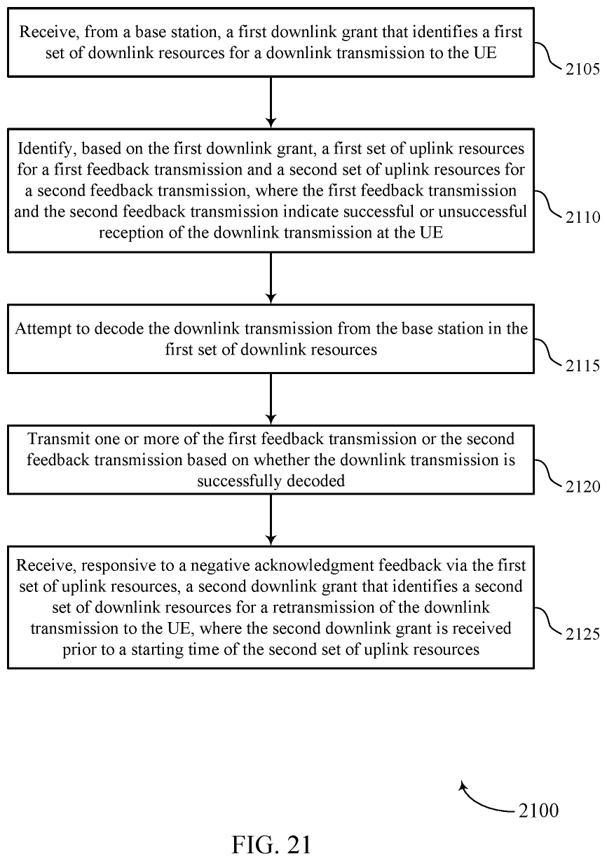

FIG. 21 shows a flowchart illustrating a method 2100 that supports acknowledgment feedback techniques in wireless communications in accordance with aspects of the present disclosure. The operations of method 2100 may be implemented by a UE 115 or its components as described herein. For example, the operations of method 2100 may be performed by a communications manager as described with reference to FIGS. 12 through 15. In some examples, a UE may execute a set of instructions to control the functional elements of the UE to perform the functions described below. Additionally or alternatively, a UE may perform aspects of the functions described below using special-purpose hardware.

At 2105, the UE may receive, from a base station, a first downlink grant that identifies a first set of downlink resources for a downlink transmission to the UE. The operations of 2105 may be performed according to the methods described herein. In some examples, aspects of the operations of 2105 may be performed by a DCI manager as described with reference to FIGS. 12 through 15.

At 2110, the UE may identify, based on the first downlink grant, a first set of uplink resources for a first feedback transmission and a second set of uplink resources for a second feedback transmission, where the first feedback transmission and the second feedback transmission indicate successful or unsuccessful reception of the downlink transmission at the UE. The operations of 2110 may be performed according to the methods described herein. In some examples, aspects of the operations of 2110 may be performed by a resource allocation manager as described with reference to FIGS. 12 through 15.

At 2115, the UE may attempt to decode the downlink transmission from the base station in the first set of downlink resources. The operations of 2115 may be performed according to the methods described herein. In some examples, aspects of the operations of 2115 may be performed by a decoder as described with reference to FIGS. 12 through 15.

At 2120, the UE may transmit one or more of the first feedback transmission or the second feedback transmission based on whether the downlink transmission is successfully decoded. The operations of 2120 may be performed according to the methods described herein. In some examples, aspects of the operations of 2120 may be performed by a feedback manager as described with reference to FIGS. 12 through 15.

At 2125, the UE may receive, responsive to a negative acknowledgment feedback via the first set of uplink resources, a second downlink grant that identifies a second set of downlink resources for a retransmission of the downlink transmission to the UE, where the second downlink grant is received prior to a starting time of the second set of uplink resources. The operations of 2125 may be performed according to the methods described herein. In some examples, aspects of the operations of 2125 may be performed by a DCI manager as described with reference to FIGS. 12 through 15.

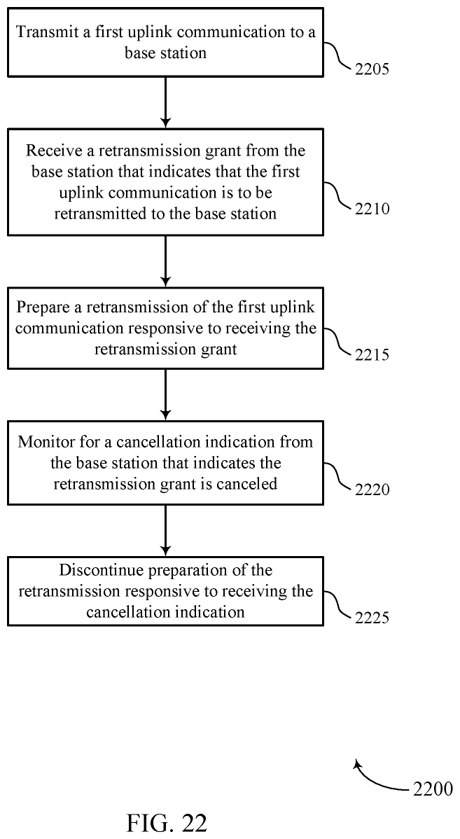

FIG. 22 shows a flowchart illustrating a method 2200 that supports acknowledgment feedback techniques in wireless communications in accordance with aspects of the present disclosure. The operations of method 2200 may be implemented by a UE 115 or its components as described herein. For example, the operations of method 2200 may be performed by a communications manager as described with reference to FIGS. 12 through 15. In some examples, a UE may execute a set of instructions to control the functional elements of the UE to perform the functions described below. Additionally or alternatively, a UE may perform aspects of the functions described below using special-purpose hardware.

At 2205, the UE may transmit a first uplink communication to a base station. The operations of 2205 may be performed according to the methods described herein. In some examples, aspects of the operations of 2205 may be performed by a transmission/reception manager as described with reference to FIGS. 12 through 15.

At 2210, the UE may receive a retransmission grant from the base station that indicates that the first uplink communication is to be retransmitted to the base station. The operations of 2210 may be performed according to the methods described herein. In some examples, aspects of the operations of 2210 may be performed by a resource allocation manager as described with reference to FIGS. 12 through 15.

At 2215, the UE may prepare a retransmission of the first uplink communication responsive to receiving the retransmission grant. The operations of 2215 may be performed according to the methods described herein. In some examples, aspects of the operations of 2215 may be performed by a transmission/reception manager as described with reference to FIGS. 12 through 15.

At 2220, the UE may monitor for a cancellation indication from the base station that indicates the retransmission grant is canceled. The operations of 2220 may be performed according to the methods described herein. In some examples, aspects of the operations of 2220 may be performed by a feedback manager as described with reference to FIGS. 12 through 15.

At 2225, the UE may discontinue preparation of the retransmission responsive to receiving the cancellation indication. The operations of 2225 may be performed according to the methods described herein. In some examples, aspects of the operations of 2225 may be performed by a transmission/reception manager as described with reference to FIGS. 12 through 15.

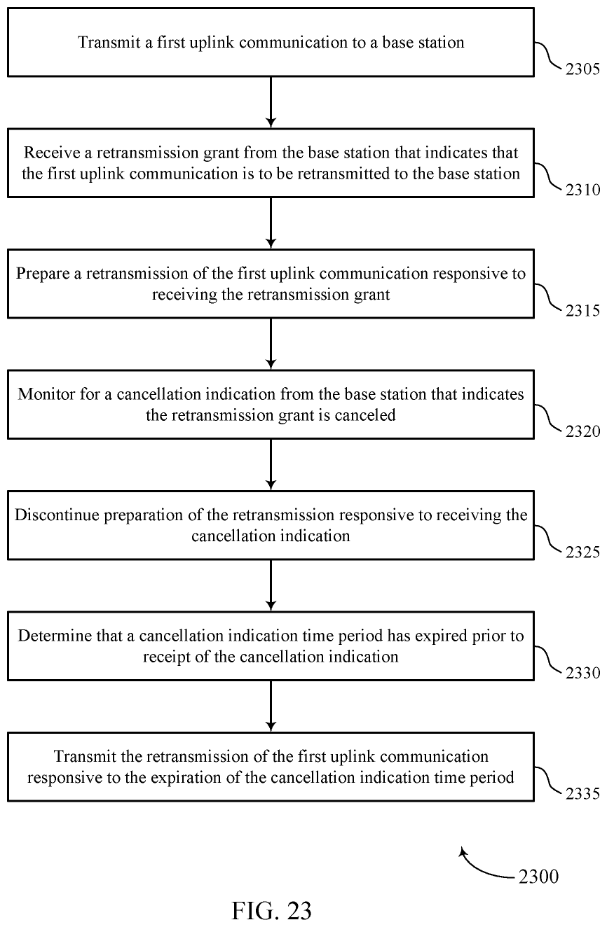

FIG. 23 shows a flowchart illustrating a method 2300 that supports acknowledgment feedback techniques in wireless communications in accordance with aspects of the present disclosure. The operations of method 2300 may be implemented by a UE 115 or its components as described herein. For example, the operations of method 2300 may be performed by a communications manager as described with reference to FIGS. 12 through 15. In some examples, a UE may execute a set of instructions to control the functional elements of the UE to perform the functions described below. Additionally or alternatively, a UE may perform aspects of the functions described below using special-purpose hardware.

At 2305, the UE may transmit a first uplink communication to a base station. The operations of 2305 may be performed according to the methods described herein. In some examples, aspects of the operations of 2305 may be performed by a transmission/reception manager as described with reference to FIGS. 12 through 15.

At 2310, the UE may receive a retransmission grant from the base station that indicates that the first uplink communication is to be retransmitted to the base station. The operations of 2310 may be performed according to the methods described herein. In some examples, aspects of the operations of 2310 may be performed by a resource allocation manager as described with reference to FIGS. 12 through 15.

At 2315, the UE may prepare a retransmission of the first uplink communication responsive to receiving the retransmission grant. The operations of 2315 may be performed according to the methods described herein. In some examples, aspects of the operations of 2315 may be performed by a transmission/reception manager as described with reference to FIGS. 12 through 15.

At 2320, the UE may monitor for a cancellation indication from the base station that indicates the retransmission grant is canceled. The operations of 2320 may be performed according to the methods described herein. In some examples, aspects of the operations of 2320 may be performed by a feedback manager as described with reference to FIGS. 12 through 15.

At 2325, the UE may discontinue preparation of the retransmission responsive to receiving the cancellation indication. The operations of 2325 may be performed according to the methods described herein. In some examples, aspects of the operations of 2325 may be performed by a transmission/reception manager as described with reference to FIGS. 12 through 15.

At 2330, the UE may determine that a cancellation indication time period has expired prior to receipt of the cancellation indication. The operations of 2330 may be performed according to the methods described herein. In some examples, aspects of the operations of 2330 may be performed by a feedback manager as described with reference to FIGS. 12 through 15.

At 2335, the UE may transmit the retransmission of the first uplink communication responsive to the expiration of the cancellation indication time period. The operations of 2335 may be performed according to the methods described herein. In some examples, aspects of the operations of 2335 may be performed by a transmission/reception manager as described with reference to FIGS. 12 through 15.

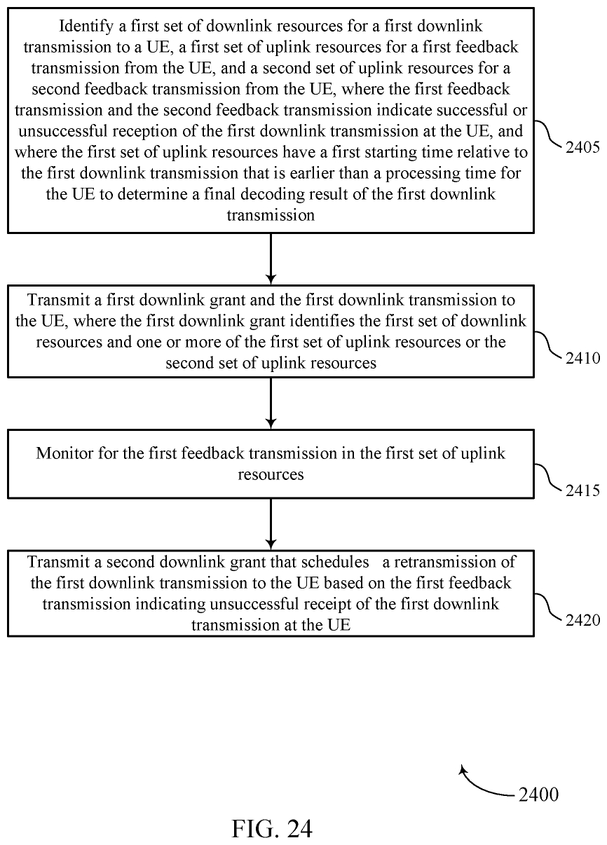

FIG. 24 shows a flowchart illustrating a method 2400 that supports acknowledgment feedback techniques in wireless communications in accordance with aspects of the present disclosure. The operations of method 2400 may be implemented by a base station 105 or its components as described herein. For example, the operations of method 2400 may be performed by a communications manager as described with reference to FIGS. 16 through 19. In some examples, a base station may execute a set of instructions to control the functional elements of the base station to perform the functions described below. Additionally or alternatively, a base station may perform aspects of the functions described below using special-purpose hardware.

At 2405, the base station may identify a first set of downlink resources for a first downlink transmission to a UE, a first set of uplink resources for a first feedback transmission from the UE, and a second set of uplink resources for a second feedback transmission from the UE, where the first feedback transmission and the second feedback transmission indicate successful or unsuccessful reception of the first downlink transmission at the UE, and where the first set of uplink resources have a first starting time relative to the first downlink transmission that is earlier than a processing time for the UE to determine a final decoding result of the first downlink transmission. The operations of 2405 may be performed according to the methods described herein. In some examples, aspects of the operations of 2405 may be performed by a resource allocation manager as described with reference to FIGS. 16 through 19.

At 2410, the base station may transmit a first downlink grant and the first downlink transmission to the UE, where the first downlink grant identifies the first set of downlink resources and one or more of the first set of uplink resources or the second set of uplink resources. The operations of 2410 may be performed according to the methods described herein. In some examples, aspects of the operations of 2410 may be performed by a DCI manager as described with reference to FIGS. 16 through 19.

At 2415, the base station may monitor for the first feedback transmission in the first set of uplink resources. The operations of 2415 may be performed according to the methods described herein. In some examples, aspects of the operations of 2415 may be performed by a feedback manager as described with reference to FIGS. 16 through 19.

At 2420, the base station may transmit a second downlink grant that schedules a retransmission of the first downlink transmission to the UE based on the first feedback transmission indicating unsuccessful receipt of the first downlink transmission at the UE. The operations of 2420 may be performed according to the methods described herein. In some examples, aspects of the operations of 2420 may be performed by a retransmission manager as described with reference to FIGS. 16 through 19.

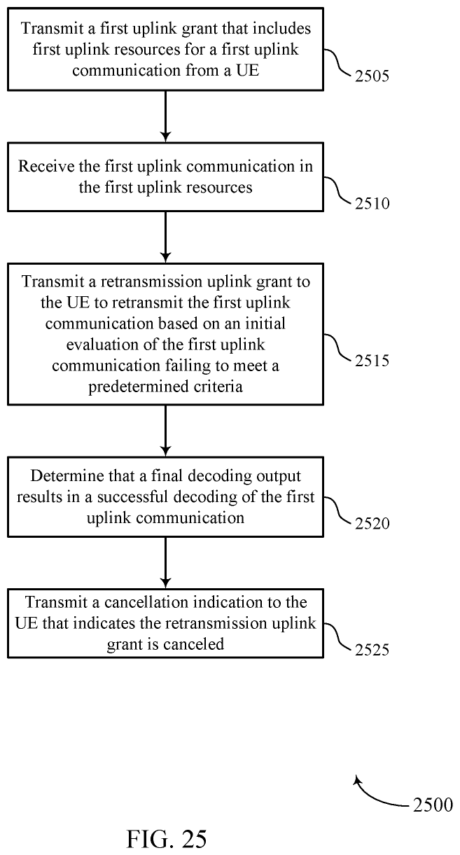

FIG. 25 shows a flowchart illustrating a method 2500 that supports acknowledgment feedback techniques in wireless communications in accordance with aspects of the present disclosure. The operations of method 2500 may be implemented by a base station 105 or its components as described herein. For example, the operations of method 2500 may be performed by a communications manager as described with reference to FIGS. 16 through 19. In some examples, a base station may execute a set of instructions to control the functional elements of the base station to perform the functions described below. Additionally or alternatively, a base station may perform aspects of the functions described below using special-purpose hardware.

At 2505, the base station may transmit a first uplink grant that includes first uplink resources for a first uplink communication from a UE. The operations of 2505 may be performed according to the methods described herein. In some examples, aspects of the operations of 2505 may be performed by a DCI manager as described with reference to FIGS. 16 through 19.

At 2510, the base station may receive the first uplink communication in the first uplink resources. The operations of 2510 may be performed according to the methods described herein. In some examples, aspects of the operations of 2510 may be performed by a transmission/reception manager as described with reference to FIGS. 16 through 19.

At 2515, the base station may transmit a retransmission uplink grant to the UE to retransmit the first uplink communication based on an initial evaluation of the first uplink communication failing to meet a predetermined criteria. The operations of 2515 may be performed according to the methods described herein. In some examples, aspects of the operations of 2515 may be performed by a DCI manager as described with reference to FIGS. 16 through 19.

At 2520, the base station may determine that a final decoding output results in a successful decoding of the first uplink communication. The operations of 2520 may be performed according to the methods described herein. In some examples, aspects of the operations of 2520 may be performed by a decoder as described with reference to FIGS. 16 through 19.

At 2525, the base station may transmit a cancellation indication to the UE that indicates the retransmission uplink grant is canceled. The operations of 2525 may be performed according to the methods described herein. In some examples, aspects of the operations of 2525 may be performed by a retransmission manager as described with reference to FIGS. 16 through 19.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving, from a base station, a first downlink grant that identifies a first set of downlink resources for a downlink transmission to the UE;
identifying, based at least in part on the first downlink grant, a first set of uplink resources for a first feedback transmission and a second set of uplink resources for a second feedback transmission, wherein the first feedback transmission and the second feedback transmission indicate successful or unsuccessful reception of the downlink transmission at the UE;
attempting to decode the downlink transmission from the base station in the first set of downlink resources; and
transmitting one or more of the first feedback transmission or the second feedback transmission based at least in part on whether the downlink transmission is successfully decoded.

2. The method of claim 1, wherein attempting to decode the downlink transmission comprises:
performing an initial decoding of the downlink transmission, and wherein the first feedback transmission is based at least in part on the initial decoding of the downlink transmission.

3. The method of claim 2, wherein attempting to decode the downlink transmission further comprises:
determining, after the initial decoding, a final decoding result of the downlink transmission, and wherein the second feedback transmission is based at least in part on the final decoding result of the downlink transmission.

4. The method of claim 3, wherein:
the initial decoding has a first processing time that is shorter than a second processing time associated with the final decoding, and wherein the starting time of the first set of uplink resources is later than a reference time plus the first processing time.

5. The method of claim 4, wherein:
the reference time corresponds to an end time of the downlink transmission or to an end time of a demodulation reference signal transmitted in the downlink transmission.

6. The method of claim 4, wherein:
a gap in time between an end time of the downlink transmission and a starting time of the first set of uplink resources is smaller than the second processing time for the UE to determine the final decoding result of the downlink transmission.

7. The method of claim 2, wherein performing the initial decoding comprises:
determining that a received power of the downlink transmission exceeds a threshold value, wherein the received power is measured based on either a reference signal transmitted with a downlink control channel or a reference signal transmitted with a downlink data channel.

8. The method of claim 2, wherein performing the initial decoding comprises:
performing a first number of decoding iterations on the downlink transmission, wherein the first number of decoding iterations is less than a second number of decoding iterations to determine a final decoding result of the downlink transmission.

9. The method of claim 1, wherein:
the first set of uplink resources at least partially overlaps in time with the first set of downlink resources.

10. The method of claim 1, further comprising:
receiving, responsive to a negative acknowledgment feedback via the first set of uplink resources, a second downlink grant that identifies a second set of downlink resources for a retransmission of the downlink transmission to the UE, wherein the second downlink grant is received prior to a starting time of the second set of uplink resources,
wherein the second downlink grant indicates a single set of uplink resources for acknowledgment of the retransmission of the downlink transmission, and the UE transmits a single feedback transmission to acknowledge receipt of the retransmission of the downlink transmission based at least in part on the single set of uplink resources.

11. The method of claim 1, wherein identifying the first set of uplink resources and the second set of uplink resources comprises:
receiving a resource indicator with the first downlink grant; and
determining the first set of uplink resources and the second set of uplink resources based at least in part on a mapping of uplink resource pairs to an index value of the resource indicator.

12. The method of claim 1, wherein identifying the first set of uplink resources and the second set of uplink resources comprises:
receiving a first resource indicator with the first downlink grant that indicates the first set of uplink resources, and a second resource indicator with the first downlink grant that indicates the second set of uplink resources.

13. The method of claim 1, wherein identifying the first set of uplink resources and the second set of uplink resources comprises:
receiving a resource indicator with the first downlink grant that indicates the first set of uplink resources; and
determining the second set of uplink resources based on a mapping between the first set of uplink resources and the second set of uplink resources,
wherein the mapping indicates a relative timing difference between a first starting time of the first set of uplink resources and a second starting time of the second set of uplink resources.

14. The method of claim 1, wherein transmitting one or more of the first feedback transmission or the second feedback transmission comprises:
transmitting the first feedback transmission based at least in part on an initial decoding of the downlink transmission indicating that the downlink transmission is unsuccessfully received; or
skipping the transmitting of the first feedback transmission based at least in part on the initial decoding of the downlink transmission indicating that the downlink transmission is successfully received,
wherein transmitting one or more of the first feedback transmission or the second feedback transmission further comprises:
transmitting the second feedback transmission based at least in part on a final decoding result of the downlink transmission.

15. The method of claim 1, wherein transmitting one or more of the first feedback transmission or the second feedback transmission comprises:
transmitting the first feedback transmission based at least in part on an initial decoding of the downlink transmission, the first feedback transmission indicating that the downlink transmission is successfully or unsuccessfully received at the UE; and
transmitting the second feedback transmission based at least in part on a final decoding of the downlink transmission when the first feedback transmission indicates unsuccessful decoding of the downlink transmission.

16. The method of claim 1, wherein transmitting one or more of the first feedback transmission or the second feedback transmission comprises:
transmitting the first feedback transmission based at least in part on an initial decoding of the downlink transmission, the first feedback transmission indicating that the downlink transmission is successfully or unsuccessfully received at the UE; and
skipping the transmission of the second feedback transmission when the first feedback transmission indicates successful decoding of the downlink transmission.

17. The method of claim 1, wherein transmitting one or more of the first feedback transmission or the second feedback transmission further comprises:
transmitting a channel quality indication with the first feedback transmission,
wherein the channel quality indication provides a difference between a reference signal measurement of a reference signal provided with the downlink transmission and a prior reference signal measurement reported to the base station.

18. The method of claim 17, wherein:
the first feedback transmission indicates successful or unsuccessful reception of the downlink transmission based at least in part on a value of the difference indicated in the channel quality indication.

19. The method of claim 17, wherein:
a modulation and coding scheme (MCS) for a retransmission of the downlink transmission is based at least in part on an initial MCS of the downlink transmission and the difference indicated in the channel quality indication.

20. The method of claim 1, wherein the downlink transmission comprises two or more concurrent downlink transmissions, and wherein transmitting one or more of the first feedback transmission or the second feedback transmission comprises:
multiplexing feedback information for the two or more concurrent downlink transmissions in one or more of the first feedback transmission or the second feedback transmission.

21. The method of claim 1, further comprising:
transmitting a capability indication to the base station that indicates a UE capability to transmit uplink feedback using one or more of the first set of uplink resources or the second set of uplink resources.

22. The method of claim 1, further comprising:
receiving, via a radio resource control configuration or a downlink grant, an indication of a feedback mode of the UE, wherein transmitting one or more of the first feedback transmission or the second feedback transmission is further based at least in part on the feedback mode of the UE.

23. A method for wireless communication at a user equipment (UE), comprising:
transmitting a first uplink communication to a base station;
receiving a retransmission grant from the base station that indicates that the first uplink communication is to be retransmitted to the base station;
preparing a retransmission of the first uplink communication responsive to receiving the retransmission grant;
monitoring for a cancellation indication from the base station that indicates the retransmission grant is canceled; and
discontinuing preparation of the retransmission responsive to receiving the cancellation indication.

24. The method of claim 23, further comprising:
determining that a cancellation indication time period has expired prior to receipt of the cancellation indication; and
transmitting the retransmission of the first uplink communication responsive to the expiration of the cancellation indication time period.

25. An apparatus for wireless communication at a user equipment (UE), comprising:
a processor,
memory in electronic communication with the processor; and
instructions stored in the memory and executable by the processor to cause the apparatus to:
receive, from a base station, a first downlink grant that identifies a first set of downlink resources for a downlink transmission to the UE;
identify, based at least in part on the first downlink grant, a first set of uplink resources for a first feedback transmission and a second set of uplink resources for a second feedback transmission, wherein the first feedback transmission and the second feedback transmission indicate successful or unsuccessful reception of the downlink transmission at the UE;
attempt to decode the downlink transmission from the base station in the first set of downlink resources; and
transmit one or more of the first feedback transmission or the second feedback transmission based at least in part on whether the downlink transmission is successfully decoded.

26. The apparatus of claim 25, wherein the instructions to attempt to decode the downlink transmission are executable by the processor to cause the apparatus to:
perform an initial decoding of the downlink transmission, and wherein the first feedback transmission is based at least in part on the initial decoding of the downlink transmission,
wherein the instructions to attempt to decode the downlink transmission further are executable by the processor to cause the apparatus to:
determine, after the initial decoding, a final decoding result of the downlink transmission, and wherein the second feedback transmission is based at least in part on the final decoding result of the downlink transmission,
wherein the initial decoding has a first processing time that is shorter than a second processing time associated with the final decoding, and wherein the starting time of the first set of uplink resources is later than a reference time plus the first processing time.

27. The apparatus of claim 26, wherein the reference time corresponds to an end time of the downlink transmission or to an end time of a demodulation reference signal transmitted in the downlink transmission.

28. The apparatus of claim 26, wherein a gap in time between an end time of the downlink transmission and a starting time of the first set of uplink resources is smaller than the second processing time for the UE to determine the final decoding result of the downlink transmission.

29. The apparatus of claim 25, the instructions being executable by the processor to further cause the apparatus to:
receive, via a radio resource control configuration or a downlink grant, an indication of a feedback mode of the UE, wherein transmission of one or more of the first feedback transmission or the second feedback transmission is further based at least in part on the feedback mode of the UE.

30. An apparatus for wireless communication at a user equipment (UE), comprising:
a processor,
memory in electronic communication with the processor; and
instructions stored in the memory and executable by the processor to cause the apparatus to:
transmit a first uplink communication to a base station;
receive a retransmission grant from the base station that indicates that the first uplink communication is to be retransmitted to the base station;
prepare a retransmission of the first uplink communication responsive to receiving the retransmission grant;
monitor for a cancellation indication from the base station that indicates the retransmission grant is canceled; and
discontinue preparation of the retransmission responsive to receiving the cancellation indication.
